(19) United States
(12) Patent Application Publication
(10) Pub. No.: US 2018/0043212 A1
(43) Pub. Date: Feb. 15, 2018

(54) System, method, and non-transitory computer readable medium for recommending a route based on a user's physical condition

(71) Applicant: SEIKO EPSON CORPORATION, Tokyo (JP)

(72) Inventors: Tsubasa SHIRAI, Shiojiri-shi (JP); Masao KURODA, Shiojiri-shi (JP); Ayako FUJITA, Shiojiri-shi (JP)

(73) Assignee: SEIKO EPSON CORPORATION, Tokyo (JP)

(21) Appl. No.: 15/675,204

(22) Filed: Aug. 11, 2017

(30) Foreign Application Priority Data
Aug. 12, 2016 (JP) 2016-158888

(51) Int. Cl. A63B 24/00; G01C 21/34; G01C 21/36; A63B 71/06

(52) U.S. Cl. CPC A63B 24/0062; A63B 71/0622; G01C 21/3484; G01C 21/3617

(57) ABSTRACT

A system that acquires physical condition information concerning a physical condition of a user before starting an activity and outputs, on the basis of the physical condition information, a recommended route, which is a route recommended for the user to run as the activity.

This application claims foreign priority to Japanese Patent Application No. 2016-158888 filed Aug. 12, 2016, which is hereby incorporated by reference herein in its entirety.

### BACKGROUND

### 1. Technical Field

The present disclosure relates to an information output system, an information output method, and an information output program.

### 2. Related Art

During the recent health boom, the general interest of people is directed to health more than ever before. Under these circumstances, commodities, electronic devices, and services that support users from both aspects of life and exercise have emerged that play an important role in the markets of wearable devices and wearable services. The demand for these wearable devices and wearable services is to provide analyses and advices matching individual users.

United State Patent Application Publication No. 2013/0345978 (Patent Literature 1) discloses an activity monitoring system that displays a route in which activities are performed. The system displays a popularity level, an activity level, and the like on a heat map and allows users to share courses in which the other users ran. Therefore, the system is effective as a support when the users examine running courses of the users in the future.

However, for example, when a physical condition of a user is bad or when the physical condition is better than normal, the user may not always select a course optimum for the individual user.

### SUMMARY

An advantage of some aspects of the disclosure is to provide an information output system, an information output method, and an information output program that can recommend an exercising user a route suitable for a physical condition of the user.

The disclosure can be implemented as the following forms or application examples.

### Application Example 1

An information output system according to this application example includes: an acquiring unit configured to acquire physical condition information concerning a physical condition of a user before a start of an activity; and an output unit configured to present, on the basis of the physical condition information, a recommended route recommended to the user as a route in which the user performs the activity.

The acquiring unit acquires physical condition information concerning a physical condition of a user before the start of an activity. The output unit presents, on the basis of the physical condition information, a recommended route recommended to the user as a route in which the user performs the activity. Therefore, the information output system can recommend a route suitable for the physical condition of the user to the user.

### Application Example 2

In this application example, the physical condition information may be information based on data from a sensor concerning the user.

Since the physical condition information is information based on the data from the sensor concerning the user, the physical condition information objectively represents a state of the user. Therefore, a route recommended to the user by the information output system is suitable for the physical condition of the user.

### Application Example 3

In this application example, the sensor may include at least one of a position sensor, a direction sensor, an air pressure sensor, an acceleration sensor, an angular velocity sensor, a pulse sensor, and a temperature sensor.

Therefore, the information output system can reflect at least one of the position, the direction, the air pressure, the acceleration, the angular velocity, the pulse, and the temperature of the user on content of the recommended route.

### Application Example 4

In this application example, the data from the sensor may include at least one of data detected by the at least one sensor and data obtained by processing the data detected by the at least one sensor.

Therefore, the information output system can reflect at least one of data detected by the at least one sensor and data obtained by processing the data on content of the recommended route.

### Application Example 5

In this application example, the physical condition information may be information based on information input by the user.

Therefore, the information output system can reflect physical condition information based on information input by the user on content of the recommended route.

### Application Example 6

In this application example, the physical condition information may include at least one of information concerning a state of a mind of the user and information concerning a state of a body of the user.

Therefore, the information output system can reflect at least one of information concerning a state of a mind of the user and information concerning a state of a body of the user on content of the recommended route.

### Application Example 7

In this application example, the output unit may present, as the recommended route, at least one route present within a predetermined distance from a position of the user before the start of the activity.

Therefore, since the information output system presents a route present within the predetermined distance from the position of the user, it is possible to present a route easier for the user to access than when a route present in a position more distant than the predetermined distance is presented.

### Application Example 8

In this application example, the output unit may present, as the recommended route, a route having a high degree of recommendation among two or more routes present within a predetermined distance from a position of the user before the start of the activity.

Therefore, the information output system can more preferentially present a route having a relatively high degree of recommendation to the user than a route having a relatively low recommendation degree.

### Application Example 9

In this application example, when the user is moving in the recommended route, the output unit may display visual representation of a section in which the user moves in the recommended route differently from a visual representation of a section in which the user does not move.

Therefore, the information output system can visually distinguish a section in which the user moves and a section in which the user does not move in the recommended route and present the sections to the user.

### Application Example 10

An information output method according to this application example includes: acquiring physical condition information concerning a physical condition of a user before a start of an activity; and presenting, on the basis of the physical condition information, a recommended route recommended to the user as a route in which the user performs the activity.

In the information output method according to this application example, physical condition information concerning a physical condition of a user before the start of an activity is acquired and a recommended route recommended to the user as a route in which the user performs the activity is presented on the basis of the physical condition information. Therefore, it is possible to recommend a route suitable for the physical condition of the user to the user.

### Application Example 11

An information output program according to this application example causes a computer to execute: acquiring physical condition information concerning a physical condition of a user before a start of an activity; and presenting, on the basis of the physical condition information, a recommended route recommended to the user as a route in which the user performs the activity.

With the information output program according to this application example, the computer acquires physical condition information concerning a physical condition of a user before the start of an activity and presents, on the basis of the physical condition information, a recommended route recommended to the user as a route in which the user performs the activity. Therefore, it is possible to recommend a route suitable for the physical condition of the user to the user.

### BRIEF DESCRIPTION OF THE DRAWINGS

The disclosure will be described with reference to the accompanying drawings, wherein like numbers reference like elements.

FIG. 1 is a diagram for explaining a configuration example of a system.

FIG. 2 is a functional block diagram for explaining a configuration example of an electronic device.

FIG. 3 is a functional block diagram for explaining a configuration example of an information terminal and a server.

FIG. 4 is a diagram for explaining an example of an input screen for a degree of fatigue.

FIG. 5 is a diagram for explaining another example of the input screen for a degree of fatigue.

FIG. 6 is a diagram for explaining still another example of the input screen for a degree of fatigue.

FIG. 7 is a diagram for explaining still another example of the input screen for a degree of fatigue.

FIG. 8 is a diagram for explaining an example of a physical condition table.

FIG. 9 is a diagram for explaining an example of log data.

FIG. 10 is a diagram for explaining an example of details of the log data.

FIG. 11 is a diagram for explaining an example of data of the autonomic nerve.

FIG. 12 is a diagram for explaining an example of a method of measuring a mind balance.

FIG. 13 is a flowchart for explaining an example of deviation-degree calculation processing.

FIG. 14 is a flowchart for explaining an example of learning processing.

FIG. 15 is a diagram for explaining an example of heart rate data by training events.

FIG. 16 is a diagram for explaining an example of characteristic data by training events.

FIG. 17 is a diagram for explaining an example of a display screen for recommended events (list display).

FIG. 18 is a diagram for explaining an example of a display screen for recommended courses (map display).

FIG. 19 is a diagram for explaining an example of a display screen for recommended events (map display).

FIG. 20 is a diagram for explaining an example of a display screen for recommended menus.

FIG. 21 is a diagram for explaining an example of a display screen for recommended courses (level difference display).

FIG. 22 is a diagram for explaining an example of operation by a user for starting an application.

FIG. 23 is a diagram for explaining an example of operation for course selection by the user.

FIG. 24 is a diagram for explaining an example of a navigation screen.

FIGS. 25A and 25B are diagrams for explaining an example of the navigation screen.

FIG. 26 is a diagram for explaining another example of the navigation screen.

FIG. 27 is a diagram for explaining another example (gray out) of the navigation screen.

FIG. 28 is a diagram for explaining another example (map display) of the navigation screen during running.

FIG. 29 is a diagram for explaining course data.

FIG. 30 is a flowchart for explaining an example of course recommendation processing.

FIG. 31 is a diagram for explaining an example of a feedback screen.

FIG. 32 is a diagram for explaining an example of event determination processing (overall) for training.

FIG. 33 is a diagram for explaining an example of event determination processing (detailed) for training.

FIG. 34 is a diagram for explaining another example of the feedback screen.

FIG. 35 is a diagram for explaining an example of another example (map display) of the feedback screen.

FIG. 36 is a diagram for explaining an example of a feedback screen (altitude map).

FIG. 37 is a diagram for explaining another example of the feedback screen (map display).

FIG. 38 is a diagram for explaining an example of off-course determination processing.

### DESCRIPTION OF EXEMPLARY EMBODIMENTS

A preferred embodiment of the disclosure is explained in detail below with reference to the drawings. Note that the embodiment explained below does not unduly limit the content of the disclosure described in the appended claims. Not all of components explained below are essential constituent elements of the invention.

1. System in this Embodiment

### 1-1. Overview of the System

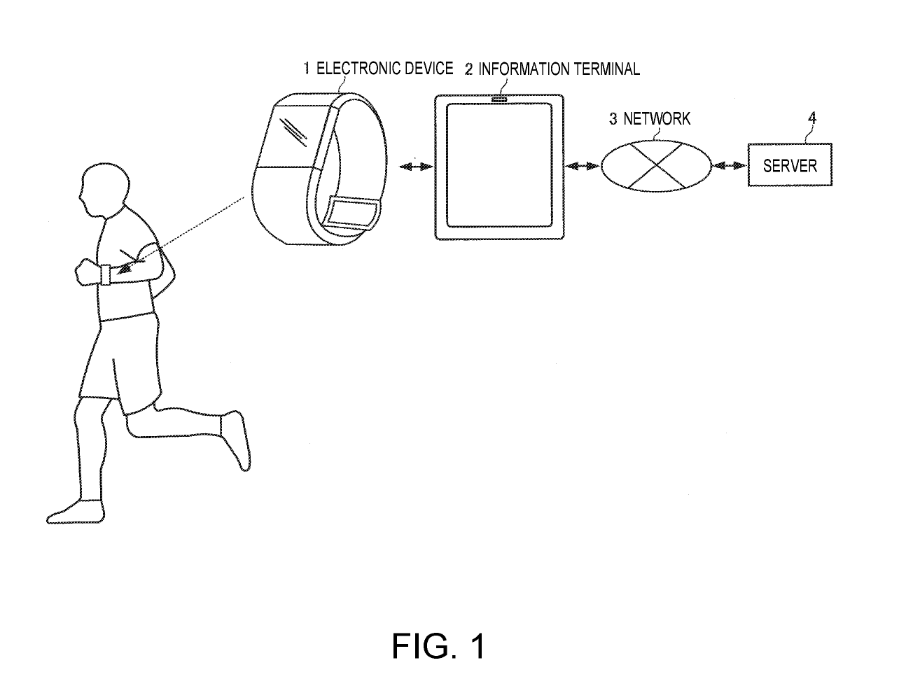

As shown in FIG. 1, an information output system (hereinafter simply referred to as “system”) in this embodiment includes, for example, an electronic device 1 of a wearing type, a portable information terminal 2 connected to a network 3, and a server 4 connected to the network 3. A user of the electronic device 1 and a user of the information terminal 2 are the same. The electronic device 1 and the information terminal 2 are capable of communicating with each other at an appropriate time through short-range wireless communication or the like. The information terminal 2 is capable of communicating with the server 4 via the network 3 such as the Internet. Note that information terminals (not shown in the figure) used by other users are also connected to the network 3. The information terminals are capable of communicating with electronic devices (not shown in the figure) of the other users through the short-range wireless communication or the like.

A function of recording (logging) data concerning a life of the user (a life logger function) and a function of recording (logging) data concerning exercise of the user (a performance monitor function) is mounted on the electronic device 1 of the user. At least one of the life logger function and the performance monitor function is mounted on the electronic devices of the other users as well. However, it is assumed that both of the life logger function and the performance monitor function are mounted on the electronic device 1 of the user. The electronic device 1 is focused on below.

The electronic device 1 is a wearable portable information device worn on a part of the body of the user. The electronic device 1 is worn in, for example, apart (a forearm) between an elbow and a hand such that the user can view the electronic device 1 when necessary. In the example shown in FIG. 1, the electronic device 1 is configured as a portable information device of a wrist type (a wristwatch type). The electronic device 1 includes a belt, which is a fixture for wearing the electronic device 1 on a wrist of the user. For example, one or a plurality of operation units configured by mechanical switches may be provided on the outer edge portion of a display unit of the electronic device 1. The display unit of the electronic device 1 may be configured by a touch panel display. The touch panel display may have a function of an operation unit. Besides a clocking function, the life logger function and the performance monitor function are mounted on the electronic device 1. Therefore, various sensing functions for acquiring data concerning life and exercise from the body of the user are mounted on the electronic device 1. In the following explanation, data acquired from the body of the user and recorded in the electronic device 1 (data concerning life and exercise) is referred to as “log data”.

The information terminal 2 is an information terminal such as a smartphone, a tablet PC (personal computer), or a desktop PC connectable to the network 3 such as the Internet. However, it is assumed that the information terminal 2 is a portable information terminal carried by the user together with the electronic device 1. The information terminal 2 is used when data received from the server 4 via the network 3 is transferred to the electronic device 1 or log data written in a storing unit of the electronic device 1 is read and uploaded to the server 4 via the network 3. Note that a part or all of the functions of the information terminal 2 may be mounted on the electronic device 1 side.

### 1-2. Configuration of the Electronic Device

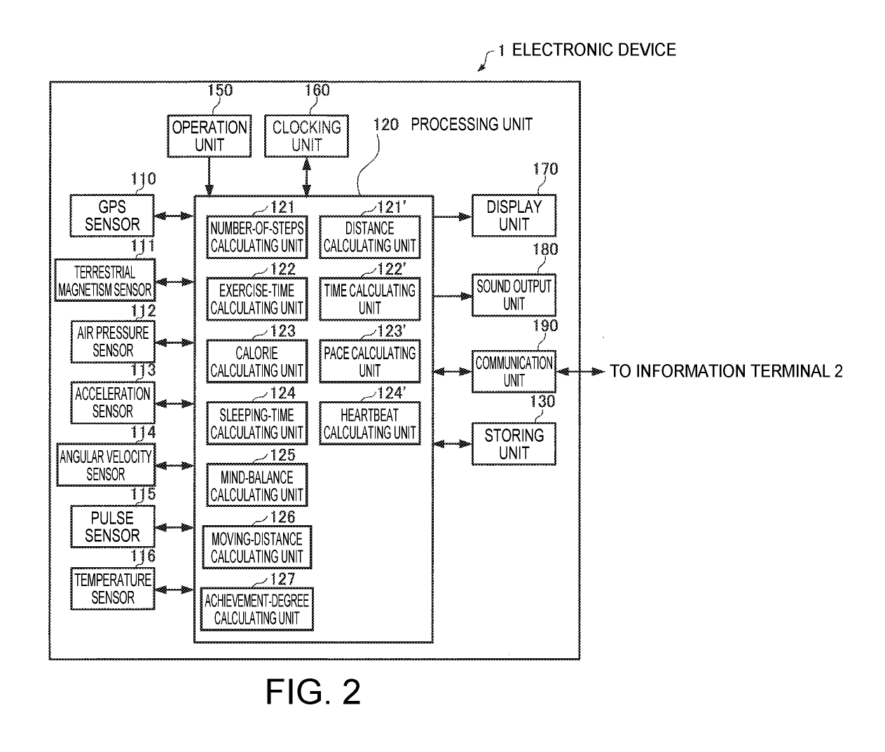

As shown in FIG. 2, the electronic device 1 includes a GPS (Global Positioning System) sensor 110 (an example of a position sensor), a terrestrial magnetism sensor 111 (an example of a direction sensor), an air pressure sensor 112, an acceleration sensor 113, an angular velocity sensor 114, a pulse sensor 115, a temperature sensor 116, a processing unit 120 (also referred to as processor), a storing unit 130, an operation unit 150, a clocking unit 160, a display unit 170 (an example of an output unit), a sound output unit 180 (an example of the output unit), and a communication unit 190. However, the configuration of the electronic device 1 may be a configuration in which a part of the components are deleted or changed or other components (e.g., a humidity sensor and an ultraviolet sensor) are added.

The GPS sensor 110 is a sensor that generates positioning data (data such as latitude, longitude, altitude, and a speed vector) indicating the position and the like of the electronic device 1 and outputs the positioning data to the processing unit 120. The GPS sensor 110 includes, for example, a GPS (global Positioning System) receiver. The GPS sensor 110 receives, with a not-shown GPS antenna, an electromagnetic wave in a predetermined frequency band arriving from the outside, extracts a GPS signal from a GPS satellite, and generates positioning data indicating the position and the like of the electronic device 1 on the basis of the GPS signal.

The terrestrial magnetism sensor 111 is a sensor that detects a terrestrial magnetism vector indicating the direction of the magnetic field of the Earth viewed from the electronic device 1. The terrestrial magnetism sensor 111 generates, for example, terrestrial magnetism data indicating magnetic flux densities in three axial directions orthogonal to one another. In the terrestrial magnetism sensor 111, for example, an MR (Magnet Resistive) element, an MI (Magnet Impedance) element, and a Hall element are used.

The air pressure sensor 112 is a sensor that detects the air pressure (the atmospheric pressure). The air pressure sensor 112 includes a pressure sensitive element of a type (a vibration type) that makes use of a change in a resonance frequency of a vibrating piece. The pressure sensitive element is a piezoelectric vibrator formed of a piezoelectric material such as quartz, lithium niobate, or lithium tantalate. For example, a tuning fork-type vibrator, a dual turning fork-type vibrator, an AT vibrator (a thickness shear vibrator), or a SAW (Surface Acoustic Wave) resonator is applied. Note that an output of the air pressure sensor 112 may be used for correcting positioning data.

The acceleration sensor 113 is an inertial sensor that detects accelerations in the respective three axial directions crossing (ideally orthogonal to) one another and outputs a digital signal (acceleration data) corresponding to the magnitudes and the directions of the detected three axis accelerations. Note that the output of the acceleration sensor 113 may be used to correct information concerning a position included in the positioning data of the GPS sensor 110.

The angular velocity sensor 114 is an inertial sensor that detects angular velocities in the respective three axial directions crossing (ideally orthogonal to) one another and outputs a digital signal (angular velocity data) corresponding to the magnitudes and the directions of the measured three axis angular velocities. Note that the output of the angular velocity sensor 114 may be used for correcting the information concerning the position included in the positioning data of the GPS sensor 110.

The pulse sensor 115 is a sensor that generates a signal indicating a pulse of the user and outputs the signal to the processing unit 120. The pulse sensor 115 includes, for example, a light source such as an LED (Light Emitting Diode) light source that irradiates measurement light having an appropriate wavelength toward a blood vessel under a skin and a light receiving element that detects an intensity change of light generated in the blood vessel according to the measurement light. Note that it is possible to measure a pulse rate (a pulse rate per one minute) by processing an intensity change waveform (pulse wave) of the light with a publicly-known method such as a frequency analysis. Note that, as the pulse sensor 115, an ultrasonic sensor that detects contraction of a blood vessel with an ultrasonic wave and measures a pulse rate may be adopted instead of a photoelectric sensor including a light source and a light receiving element. For example, a sensor that feeds a feeble current from an electrode into the body and measures a pulse rate may be adopted. Note that the pulse is obtained by indirectly measuring a heartbeat according to pulsation of a part other than the heart in the body of the user. Therefore, in this specification, the “pulse” is used in the same meaning as the “heartbeat”.

The temperature sensor 116 is a temperature sensitive element that outputs a signal corresponding to an ambient temperature (e.g., a voltage corresponding to temperature). Note that the temperature sensor 116 may be a sensor that outputs a digital signal corresponding to the temperature. The temperature sensor 116 includes, besides a sensor that detects temperature around the user, a sensor that detects the temperature of the body (body temperature) of the user.

The processing unit 120 (an example of an acquiring unit) is configured by, for example, an MPU (Micro Processing Unit), a DSP (Digital Signal Processor), or an ASIC (Application specific Integrated Circuit). The processing unit 120 performs various kinds of processing according to computer programs stored in the storing unit 130 and various commands input by the user via the operation unit 150. The processing by the processing unit 120 includes data processing for data generated by the SPS sensor 110, the terrestrial magnetism sensor 111, the air pressure sensor 112, the acceleration sensor 113, the angular velocity sensor 114, the pulse sensor 115, the temperature sensor 116, the clocking unit 160, and the like, display processing for causing the display unit 170 to display an image (an example of control for displaying an image), and sound output processing for causing the sound output unit 180 to output sound. Note that the “processing unit” is sometimes called “processor”. The processing unit 120 may be configured by a single processor or may be configured by a plurality of processors.

The storing unit 130 is configured by, for example, one or a plurality of IC (Integrated Circuit) memories. The storing unit 130 includes a ROM (Read Only Memory) in which data such as computer programs (examples of an information output program) are stored and a RAM (Random Access Memory) serving as a work area of the processing unit 120. Note that the RAM may include a nonvolatile RAM. A storage area for various data is desirably secured in the nonvolatile memory.

The operation unit 150 is configured by, for example, buttons, keys, a microphone, a touch panel, a sound recognition function (in which a not-shown microphone is used), and an action detecting function (in which the acceleration sensor 113 or the like is used). The operation unit 150 performs processing for converting an instruction from the user into an appropriate signal and sending the signal to the processing unit 120.

The clocking unit 160 is configured by, for example, a real time clock (RTC) IC. The clocking unit 160 generates time data such as year, month, day, hour, minute, and second and sends the time data to the processing unit 120.

The display unit 170 is configured by, for example, an LCD (Liquid Crystal Display), an organic EL (Electroluminescence) display, an EPD (Electrophoretic Display), or a touch panel display. The display unit 170 displays various images according to instructions from the processing unit 120.

The sound output unit 180 is configured by, for example, a speaker, a buzzer, or a vibrator. The sound output unit 180 generates various kinds of sound (or vibration) according to instructions from the processing unit 120.

The communication unit 190 performs various kinds of control for establishing data communication between the electronic device 1 and the information terminal 2 (a smartphone or the like). The communication unit 190 includes a transceiver corresponding to a short-range wireless communication standard such as Bluetooth (registered trademark) (including BTLE: Bluetooth Low Energy), Wi-Fi (Wireless Fidelity) (registered trademark), Zigbee (registered trademark), NFC (Near Field Communication), or ANT+ (registered trademark).

### 1-2-1. Details of the Processing Unit of the Electronic Device

As shown in FIG. 2, the processing unit 120 of the electronic device 1 functions as a number-of-steps calculating unit 121, an exercise-time calculating unit 122, a calorie calculating unit 123, a sleeping-time calculating unit 124, a mind-balance calculating unit 125, a moving-distance calculating unit 126, an achievement-degree calculating unit 127, a distance calculating unit 121′, a time calculating unit 122′, apace calculating unit 123′, and a heartbeat calculating unit 124′ as appropriate. Among the units, the number-of-steps calculating unit 121, the exercise-time calculating unit 122, the calorie calculating unit 123, the sleeping-time calculating unit 124, the mind-balance calculating unit 125, the moving distance calculating unit 126, and the achievement-degree calculating unit 127 are equivalent to the function of the life logger of the processing unit 120. The distance calculating unit 121′, the time calculating unit 122′, the pace calculating unit 123′, and the heartbeat calculating unit 124′ are equivalent to the function of the performance monitor of the processing unit 120.

The number-of-steps calculating unit 121 counts the number of steps of the user, for example, on the basis of an output of the acceleration sensor 113, an output of the angular velocity sensor 114, and user body data (user body data written in the storing unit 130 in advance). Note that at least one of the acceleration sensor 113 and the GPS sensor 110 can be used for the counting of the number of steps. The number-of-steps calculating unit 121 may count the number of steps at the time when a heart rate belongs to a predetermined heartbeat zone. Note that the processing unit 120 can determine on the basis of an output of the pulse sensor 115 whether the heart rate belongs to the predetermined heartbeat zone. The heartbeat zone is set on the basis of the user body data. As the heartbeat zone, there are, for example, a zone suitable for fat burning and a zone suitable for exercise ability improvement. Note that, since the calculation of the heartbeat zone is publicly known, detailed explanation of the calculation of the heartbeat zone is omitted. The heartbeat zone can also be determined on the basis of both of the heart rate and acceleration. Note that the number-of-steps calculating unit 121 calculates the number of steps in each day and the number of steps for one week including a day to which the present time belongs and writes the numbers of steps in the storing unit 130.

The exercise-time calculating unit 122 calculates an exercise time of the user on the basis of the output of the acceleration sensor 113 and the output of the angular velocity sensor 114. An output of the GPS sensor 110 may be used for the calculation of the exercise time. Note that the exercise-time calculating unit 122 may calculate an exercise time at the time when the heart rate belongs to the predetermined heartbeat zone. Note that, for example, the processing unit 120 can determine on the basis of the output of the pulse sensor 115 whether the heart rate belongs to the predetermined heartbeat zone. Note that the exercise-time calculating unit 122 calculates an exercise time in each day and an exercise time for one week including a day to which the present time belongs and writes the exercise times in the storing unit 130.

The calorie calculating unit 123 calculates a consumed calorie, for example, on the basis of the user body data and the output of the pulse sensor 115. Note that the calorie calculating unit 123 sets a basal metabolism rate of the user on the basis of age, sex, and the like included in the user body data and performs the calculation of a consumed calorie on the basis of the basal metabolism rate. The consumed calorie is calculated by a publicly-known method such as a method of calculating a consumed calorie using information such as a pulse rate, age, and sex or a method of calculating the basal metabolism rate using information such as weight and height. Note that the calorie calculating unit 123 may calculate a total value of intake calories on the basis of meal information of the user and calculate a calorie balance. Note that the calorie calculating unit 123 can cause the user to manually input the meal information of the user via, for example, the operation unit 150. The calorie calculating unit 123 calculates a consumed calorie in each day and a consumed calorie for one week including a day to which the present time belongs and writes the consumed calories in the storing unit 130.

The sleeping-time calculating unit 124 calculates a sleeping time of the user on the basis of the output of the acceleration sensor 113, an output of the angular velocity sensor 114, and the output of the pulse sensor 115. Note that the sleeping-time calculating unit 124 determines on the basis of the output of the acceleration sensor 113 and the output of the angular velocity sensor 114 whether the user is sleeping. The sleeping-time calculating unit 124 may determine on the basis of an output of the pulse sensor 115 during the sleep whether the sleep is light sleep or deep sleep and calculate a light sleep time and a deep sleep time. Note that the sleeping-time calculating unit 124 calculates a sleeping time in each day and a sleeping time for one week including a day to which the present time belongs and writes the sleeping times in the storing unit 130.

The mind-balance calculating unit 125 calculates a ratio (a mind balance) of a time in which the user is in an excited state during non-exercise (an excitement time) and a time in which the user in a relaxed state during non-exercise (a relax time), for example, on the basis of the output of the acceleration sensor 113, the output of the angular velocity sensor 114, the output of the GPS sensor 110, and the output of the pulse sensor 115. Note that the calculated excitement time may be an excitement time during exercise. The calculated relax time may be a relax time during exercise. When the transition of the output of the acceleration sensor 113 is not within an exercise acceleration range (a range of the transition of acceleration classified into exercise) and a measured pulse rate measured by the pulse sensor 115 is within an exercise pulse rate range (a range of the transition of a pulse rate classified into exercise), the mind-balance calculating unit 125 determines that the user is in an excited state not by exercise (a sympathetic nerve activated state). When the transition of the output of the acceleration sensor 113 is not within the exercise acceleration range (the range of the transition of acceleration classified into exercise) and the measured pulse rate measured by the pulse sensor 115 is not within the exercise pulse rate range (the range of the transition of a pulse rate classified into exercise), the mind-balance calculating unit 125 determines that the user in a relaxed state (a parasympathetic nerve activated state). Note that the mind-balance calculating unit 125 may calculate, using a publicly-known method, an indicator HF/LF (HF: High Frequency, LF: Low Frequency) or the like representing the sympathetic nerve and parasympathetic nerve activated states from a brain wave measured by the pulse sensor 115 and determine the excited state or the relaxed state. The mind-balance calculating unit 125 may calculate a mind balance at each time, a mind balance in each day, and a mind balance for one week including a day to which the present time belongs and write the mind balances in the storing unit 130. Note that a method of calculating a mind balance using HF/LF is explained below. Note that the mind balance based on the indicator HF/LF can also be referred to as “stress” in order to distinguish the mind balance from a mind balance based on a time of the excited state and a time of the relaxed state.

The moving-distance calculating unit 126 calculates a moving distance of the user, for example, on the basis of the output of the GPS sensor 110, the output of the terrestrial magnetism sensor 111, the output of the air pressure sensor 112, the output of the acceleration sensor 113, and the output of the angular velocity sensor 114. Note that the moving-distance calculating unit 126 can also calculate the moving distance on the basis of only the output of the GPS sensor 110. However, the moving-distance calculating unit 126 sometimes cannot receive a GPS signal depending on an environment in which the electronic device 1 is placed. Therefore, for example, on the basis of at least one of the output of the terrestrial magnetism sensor 111, the output of the air pressure sensor 112, the output of the acceleration sensor 113, and the output of the angular velocity sensor 114, the moving-distance calculating unit 126 appropriately corrects the moving distance calculated on the basis of the output of the GPS sensor 110 or estimates a moving distance in a period in which the GPS signal cannot be received. The moving-distance calculating unit 126 calculates a moving distance in each day and a moving distance for one week including a day to which the present time belongs and writes the moving distances in the storing unit 130.

The achievement-degree calculating unit 127 calculates, on the basis of the calculated number of steps, the calculated exercise time, the calculated consumed calorie, the calculated sleeping time, the calculated mind balance, and the calculated moving distance and a target number of steps, a target exercise time, a target consumed calorie, a target sleeping time, a target mind balance, and a target moving distance, at least one of a ratio of the calculated number of steps to the target number of steps (an achievement degree of the number of steps), a ratio of the calculated exercise time to the target exercise time (an achievement degree of an exercise time), a ratio of the calculated consumed calorie to the target consumed calorie (an achievement degree of a consumed calorie), a ratio of the measured sleeping time to the target sleeping time (an achievement degree of a sleeping time), a ratio of the measured mind balance to the target mind balance (an achievement degree of a mind balance), and a ratio of the measured moving distance to the target moving distance (an achievement degree of a moving distance). Note that the achievement-degree calculating unit 127 may calculate an achievement degree in each day and an achievement degree for one week including a day to which the present time belongs. The achievement-degree calculating unit 127 writes the calculated achievement degrees in the storing unit 130.

When a “lap section of time” is set as the lap section of a course in which the user moves, the distance calculating unit 121′ calculates, for example, on the basis of the output of the clocking unit 160 and the output of the GPS sensor 110, a moving distance in a period from a start point in time to an end point in time of the lap section as a lap distance of the lap section. Note that a cumulative running distance and the lap distance calculated by the distance calculating unit 121′ are written in the storing unit 130. The distance calculating unit 121′ can improve calculation accuracy of a distance using at least one of the output of the acceleration sensor 113, the output of the angular velocity sensor 114, the user body data, the output of the terrestrial magnetism sensor 111, and the output of the air pressure sensor 112.

The time calculating unit 122′ calculates, for example, on the basis of the output of the clocking unit 160, an elapsed time from a start point in time to a present point in time of the course as a split time of the user. When a “lap section of distance” is set as the lap section, the time calculating unit 122′ calculates, for example, on the basis of the output of the clocking unit 160 and the output of the GPS sensor 110, a moving time of the user in a route from a start point to an end point of the lap section as a lap time of the lap section. Note that the split time and the lap time calculated by the distance calculating unit 121′ are written in the storing unit 130. The time calculating unit 122′ can improve calculation accuracy of time by using at least one of the output of the acceleration sensor 113, the output of the angular velocity sensor 114, the user body data, the output of the terrestrial magnetism sensor 111, and the output of the air pressure sensor 112.

The pace calculating unit 123′ calculates, for example, on the basis of the output of the clocking unit 160 and the output of the GPS sensor 110, average running speed of the user from a start point to a present point of the course as an average pace of the user. When the “lap section of time” is set as the lap section, the pace calculating unit 123′ calculates, for example, on the basis of the output of the clocking unit 160 and the output of the GPS sensor 110, average running speed of the user from the start point in time to the end point in time of the lap section as a lap pace. When the “lap section of distance” is set as the lap section, the pace calculating unit 123′ calculates, for example, on the basis of the output of the clocking unit 160 and the output of the GPS sensor 110, average running speed of the user in a route from a start point and an end point of the lap section as a lap pace.

The heartbeat calculating unit 124′ calculates, for example, on the basis of the output of the clocking time 160 and the output of the pulse sensor 115, an average heart rate per unit time of the user from the start point in time to the present point in time of the course. When the “lap section of time” is set as the lap section, the heartbeat calculating unit 124′ calculates, for example, on the basis of the output of the clocking unit 160 and the output of the pulse sensor 115, an average heart rate of the user in the period from the start point in time to the endpoint in time of the lap section as a lap heart rate. When the “lap section of distance” is set as the lap section, the heartbeat calculating unit 124′ calculates, for example, on the basis of the output of the clocking unit 160 and the output of the pulse sensor 115, an average heart rate of the user in the route from the start point to the end point of the lap section as a lap heart rate.

### 1-3. Configuration of the Information Terminal

The information terminal 2 is an information terminal such as a smartphone, a tablet PC, or a desktop PC connectable to the network 3 such as the Internet.

As shown in FIG. 3, the information terminal 2 includes a processing unit 21, a communication unit 22, an operation unit 23, a storing unit 24, a display unit 25, a sound output unit 26, a communication unit 27, and an imaging unit 28. However, the information terminal 2 may have a configuration in which a part of the components are deleted or changed or other components are added as appropriate.

The processing unit 21 is configured by a CPU (Central Processing Unit), a DSP (Digital Signal Processor), an ASIC (Application Specific Integrated Circuit), or the like. The processing unit 21 performs various kinds of processing according to computer programs (examples of the information output program) stored in the storing unit 24 and various commands input by the user via the operation unit 23. The processing by the processing unit 21 includes data processing for data generated by the electronic device 1, display processing for causing the display unit 25 to display an image, sound output processing for causing the sound output unit 26 to output sound, and image processing for an image acquired by the imaging unit 28. Note that the processing unit 21 may be configured by a single processor or may be configured by a plurality of processors.

The communication unit 22 performs, for example, processing for receiving data (measurement data) or the like transmitted in a predetermined format from the electronic device 1 and sending the data or the like to the processing unit 21 and processing for transmitting a control command received from the processing unit 21 to the electronic device 1.

The operation unit 23 performs processing for acquiring data corresponding to operation of the user and sending the data to the processing unit 21. The operation unit 23 may be, for example, a touch panel display, buttons, keys, a microphone, or the like.

The storing unit 24 is configured by, for example, any of various IC memories such as a ROM, a flash ROM, or a RAM or a recording medium such as a hard disk or a memory card. The storing unit 24 has stored therein computer programs for the processing unit 21 to perform various kinds of calculation processing and control processing, various computer programs (examples of the information output program) for realizing application functions, data, and the like. The storing unit 24 is used as a work area of the processing unit 21 and temporarily stores data acquired by the operation unit 23, results of arithmetic operations executed by the processing unit 21 according to the various computer programs, and the like. Further, the storing unit 24 may store data that needs to be saved for a long period among data generated by the processing by the processing unit 21. Note that the RAM may include a nonvolatile RAM. A storage area for various data is desirably secured in the nonvolatile memory.

The display unit 25 displays a processing result of the processing unit 21 as characters, a graph, a table, an animation, or other images. The display unit 25 may be, for example, a CRT (Cathode Ray Tube), an LCD (Liquid Crystal Display), a touch panel display, or a head mounted display (HMD). Note that the functions of the operation unit 23 and the display unit 25 may be realized by one touch panel display.

The sound output unit 26 outputs a processing result of the processing unit 21 as sound such as voice or buzzer sound. The sound output unit 26 may be, for example, a speaker or a buzzer.

The communication unit 27 performs data communication with a communication unit of the server 4 via the network 3. For example, the communication unit 27 performs processing for receiving data from the processing unit 21 and transmitting the data to the communication unit of the server 4 in a predetermined format. For example, the communication unit 27 performs processing for receiving information necessary for display of a screen from the communication unit of the server 4 and sending the information to the processing unit 21 and processing for receiving various kinds of information from the processing unit 21 and transmitting the information to the communication unit of the server 4.

The imaging unit 28 is a camera including a lens, a color imaging element, and a focus adjusting mechanism. The imaging unit 28 forms, with the imaging element, an image from an image of a field formed by the lens. Data of the image (image data) acquired by the imaging element is sent to the processing unit 21 and saved in the storing unit 24 or displayed on the display unit 25.

The processing unit 21 performs, according to the various computer programs, processing for transmitting a control command to the electronic device 1 via the communication unit 22 and various kinds of calculation processing on data received from the electronic apparatus 1 via the communication unit 22. The processing unit 21 performs, according to the various computer programs, processing for reading out data from the storing unit 24 and transmitting the data to the server 4 in a predetermined format via the communication unit 27. The processing unit 21 performs, according to the various computer programs, for example, processing for transmitting various kinds of information to the server 4 via the communication unit 27 and displaying various screens on the basis of information received from the server 4. The processing unit 21 performs other various kinds of control processing. For example, the processing unit 21 executes, on the basis of at least one of information received by the communication unit 27, information received by the communication unit 22, and information stored in the storing unit 24, processing for causing the display unit 25 to display an image (an image, a moving image, characters, signs, etc.). Note that a vibrating mechanism may be provided in the information terminal 2 or the electronic device 1. Various kinds of information may be converted into vibration information by the vibrating mechanism and notified to the user.

### 1-4. Configuration of the Server

As shown in FIG. 3, the server 4 includes a processing unit 31, a communication unit 32, and a storing unit 34. However, the server 4 may have a configuration in which a part of the components is deleted or changed or other components are added as appropriate.

The storing unit 34 is configured by, for example, any of various IC memories such as a ROM, a flash ROM, or a RAM or a recording medium such as a hard disk or a memory card. The storing unit 34 has stored therein computer programs for the processing unit 31 to perform various kinds of calculation processing and control processing, various computer programs (examples of the information output program) for realizing application functions, data, and the like. Note that the RAM may include a nonvolatile RAM. A storage area for various data is desirably secured in the nonvolatile memory.

The storing unit 34 is used as a work area of the processing unit 31 and temporarily stores, for example, results of arithmetic operations executed by the processing unit 31 according to the various computer programs. Further, the storing unit 34 may store data that needs to be saved for a long period among data generated by the processing by the processing unit 31. Note that various kinds of information stored in the storing unit 34 are explained below.

The communication unit 32 performs data communication between the information terminal 2 and the communication unit 27 via the network 3. For example, the communication unit 32 performs processing for receiving data from the communication unit 27 of the information terminal 2 and sending the data to the processing unit 31. For example, the communication unit 32 performs processing for transmitting information necessary for display of a screen to the communication unit 27 of the information terminal 2 in a predetermined format and processing for receiving information from the communication unit 27 of the information terminal 2 and sending the information to the processing unit 31.

The processing unit 31 performs, according to the various computer programs, processing for receiving data from the information terminal 2 via the communication unit 32 and causing the storing unit 34 to store the data. The processing unit 31 performs, according to the various computer programs, for example, processing for receiving various kinds of information from the information terminal 2 via the communication unit 32 and transmitting information necessary for display of various screens to the information terminal 2. The processing unit 31 performs other various kinds of control processing. The processing unit 31 may be configured by a single processor or may be configured by a plurality of processors.

### 1-5. Life Logger Function of the Electronic Device

The life logger function of the electronic device is focused on and explained below.

In preparation, the user causes the display unit 170 of the electronic device 1 to display a menu screen and inputs data concerning the body of the user (user body data) such as height, weight, age, sex, and percent of body fat. The user causes the electronic device 1 to start activity amount measurement and inputs a target (a target concerning life) of each item on the menu screen.

Thereafter, the user lives for, for example, one week in a state in which the user wears the electronic device 1 on an arm. The electronic device 1 operates as a life logger and repeats recording of log data in the storing unit 130 (the log data is log data concerning life and is the number of steps, an exercise time, a calorie, a sleeping time, a mind balance, a moving distance, an achievement degree, and the like. Consequently, log data concerning the life of the user is accumulated in the storing unit 130.

Thereafter, the user can transfer the log data (the log data concerning life) accumulated in the storing unit 130 of the electronic device 1, the user target data, the user body data, and the like to the information terminal 2 by connecting the electronic device 1 to the information terminal 2 such as the smartphone, the tablet PC, or the desktop PC via the short-range wireless communication or the like.

An example of the log data concerning life is shown in FIG. 9. The log data concerning life is at least one of a moving distance, an exercise time, the number of steps, a walking pace, a walking pitch, a step, the number of steps of fast walking, the number of steps of running, the number of ascended floors (“five floors”, “two floors”, etc.), the number of ascended stairs (“100 stairs”, “200 stairs”, etc.), a heart rate, a sleeping time, stress (a balance between an excited state and a relaxed state), an oxygen intake, perspiration, a water intake (manual input by the user), a consumed calorie, an intake calorie (manual input by the user), a calorie balance, weight (input by communication with a weight meter or manual input by the user), a waist size (manual input by the user), a balance between an nervous time and a relax time (a mind balance), a heart rate, a target achievement degree, an ultraviolet ray amount, SpO₂ (an estimated value of arterial blood oxygen saturation), and a sleeping state (ratios or points of deep, light, good, bad, or the like). Note that a part of parameters (items) may overlap in the log data concerning exercise and the log data concerning life. This is because parameters such as a heartbeat relate to both of exercise and life. Note that a value, a unit, a period, and the like of the overlapping parameters may be the same or may be different between the parameters concerning exercise and the parameters concerning life.

The user body data may be input to the information terminal 2 rather than the electronic device 1. In that case, the user body data is transferred from the information terminal 2 to the electronic device 1 according to necessity.

The user can also upload the log data (the log data concerning life), the user target data, and the user body data to the server 4 by connecting the information terminal 2 to the server 4 via the network 3 such as the Internet and cause the storing unit 34 of the server 4 to store the data. Note that the user body data of the user is stored in a log data list of the user together with the log data of the user. In the following explanation, unless particularly noted otherwise, the user body data is included in the log data list in the storing unit 34.

The user can check the log data (the log data concerning life) of the user in the information terminal 2 by connecting the information terminal 2 to the server 4 via the network 3 such as the Internet at desired timing. In that case, the user can also receive provision of various kinds of incidental information (application software programs, map data, etc.) from the server 4.

Note that, it is assumed that the user connects the information terminal 2 to the server 4 via the network 3 such as the Internet and transmits registered information such as the user body data of the user to the server 4 to thereby complete user registration in the server 4. A user ID (identification information) is allocated to the user from the server 4 according to the user registration. After the registration, the user is capable of receiving, from the server 4, provision of a service for storing the log data (the log data concerning life) and provision of the incidental information (the application software programs, the map data, etc.).

In the system in this embodiment, as the log data concerning the life of the user, the electronic device 1 acquires the number of steps, the exercise time, the calorie, the sleeping time, the mind balance, the moving distance, the achievement degree, and the like. The log data is transferred to the information terminal 2 and uploaded from the information terminal 2 to the server 4. However, the log data transferred to the information terminal 2 or the log data uploaded to the server 4 may include other information concerning the life of the user. The log data may include sensing data (an output of a sensor) for calculating information concerning the life of the user or data obtained in a calculation process. That is, a function of generating information concerning life from the sensing data (the output of the sensor) may be mounted on the electronic device 1, may be mounted on the information terminal 2, or may be mounted on the server 4. In the system in this embodiment, time information and position information are given to the respective log data to be transferred or uploaded. Time information given to certain log data is information indicating detection time of the sensing data (the output of the sensor), which is a generation source of the log data. Position information given to the log data is information indicating the position of the electronic device 1 at the detection time.

### 1-6. Performance Monitor Function of the Electronic Device

The performance monitor function of the electronic device is focused and explained below.

In preparation, the user causes the display unit 170 of the electronic device 1 to display a menu screen and inputs data concerning the body of the user (user body data) such as height, weight, age, sex, and a percent of body fat. The user performs, for example, setting of a lap section on the menu screen and switches the electronic device 1 back to a time display mode. Note that the user may input target data (a target concerning exercise) together with the body data.

Thereafter, the user performs, for example, training (also referred to as exercise; an example of an activity) involving movement in a course in a state in which the user wears the electronic device 1 on the arm. The electronic device 1 operates as a performance monitor and repeats recording of log data (the log data is log data concerning exercise and is a moving distance in each lap section, a time in each lap section, a pace in each lap section, a heart rate in each lap section, etc.) in the storing unit 130. Consequently, log data concerning exercise of the user is accumulated in the storing unit 130. The course in which the training is performed (including a course in which training will be performed in future and a course in which training was performed in the past) can also be referred to as activity route, a route of an activity, a moving route of an activity, a route for an activity, and the like. The “course” can also be referred to as “route”.

Thereafter, the user can transfer the log data (the log data concerning exercise) accumulated in the storing unit 130 of the electronic device 1, the user body data, and the like to the information terminal 2 by connecting the electronic device 1 to an information terminal such as the smartphone, the tablet PC (Personal Computer), or the desktop PC via the short-range wireless communication or the like.

An example of the log data concerning exercise is shown in FIG. 9. The log data concerning exercise is an exercise distance (a moving distance or a cumulative moving distance), an exercise time, an exercise time in a predetermined heartbeat zone, the number of steps, the number of lap steps, a pace, a pitch, a step (a stride), a split time, a lap time, cumulative ascended altitude, cumulative descended altitude, altitude (average altitude of a place where exercise is performed), a gradient, the number of times of training (the number of times of running, a maximum, an average, etc.), a target achievement degree, a form (a posture, a left-right difference, a grounding time, a right-under grounding ratio, propulsion efficiency, progress of legs, a grounding brake amount, and a grounding shock), a heart rate, a consumed calorie, an oxygen intake, VO₂max (a maximum oxygen intake), perspiration, a water intake, a predicted exercise distance (a moving distance or a predicted cumulative distance) under predetermined conditions, a time until reaching a predetermined heartbeat zone, a heartbeat recovery time, a predicted pace under the predetermined conditions, a predicted pitch under the predetermined conditions, a predicted step (a predicted stride) under the predetermined conditions, a predicted time (lap time or split time) under the predetermined conditions, a predicted consumed calorie under the predetermined conditions, an automatically generated target, an ultraviolet ray amount, SpO₂ (arterial blood oxygen saturation or may be an estimated value), a type, user performance data by types, and the like. Note that a part of parameters (items) may overlap in the log data concerning exercise and the log data concerning life. This is because parameters such as a heartbeat relate to both of exercise and life. Note that a value, a unit, a period, and the like of the overlapping parameters may be the same or may be different between the parameters concerning exercise and the parameters concerning life.

The user body data may be input to the information terminal 2 rather than the electronic device 1. In that case, the user body data is transferred from the information terminal 2 to the electronic device 1 according to necessity.

The user can also upload the log data (the log data concerning exercise), the user target data, and the user body data to the server 4 by connecting the information terminal 2 to the server 4 via the network 3 and cause the storing unit 34 of the server 4 to store the data.

The user can check the log data (the log data concerning exercise) of the user in the information terminal 2 by connecting the information terminal 2 to the server 4 via the network 3 such as the Internet at desired timing. In that case, the user can also receive provision of various kinds of incidental information (application software programs, map data, etc.) from the server 4.

Note that it is assumed that, for example, the user connects the information terminal 2 to the server 4 via a network such as the Internet in advance and transmits registered information such as the user body data of the user to the server 4 to thereby complete user registration in the server 4. A user ID (identification information) is allocated to the user from the server 4 according to the user registration. After the registration, the user is capable of receiving, from the server 4, provision of a service for storing the log data (the log data concerning exercise) and provision of the incidental information (the application software programs, the map data, etc.).

In the system in this embodiment, the electronic device 1 acquires, as the log data concerning exercise of the user, the moving distance in each lap section, the time in each lap section, the pace in each lap section, the heart rate in each lap section, and the like. The log data is transferred to the information terminal 2 and uploaded from the information terminal 2 to the server 4. However, other information concerning exercise of the user may be included in the log data transferred to the information terminal 2 or the log data uploaded to the server 4. Sensing data (an output of the sensing data) for calculating information concerning exercise of the user or data in a calculation process may be included in the log data. That is, a function of generating information concerning exercise from the sensing data (the output of the sensing data) may be mounted on the electronic device 1, may be mounted on the information terminal 2, or may be mounted on the server 4. In the system in this embodiment, time information and position information are given to the respective log data to be transferred or uploaded. Time information given to certain log data is information indicating detection time of the sensing data (the output of the sensor), which is a generation source of the log data. Position information given to the log data is information indicating the position of the electronic device 1 at the detection time.

### 1-7. Management of Log Data by the Server

Referring back to FIG. 3, the server 4 records and manages, for each user, the log data (the log data concerning life and the log data concerning exercise) uploaded from the user via the information terminal 2. In the following explanation, at least one of the log data concerning life and the log data concerning exercise is referred to as “log data” as appropriate. The log data is an example of physical condition information concerning a physical condition of the user and is an example of information based on data from the sensor. The data from the sensor includes at least one of data itself detected by at least one sensor, data obtained by processing the data detected by the at least one sensor, and data obtained by converting a format or the like of the data detected by the at least one sensor. The information based on the data from the sensor may include, in principle, at least one of information generated using a data detected by at least one sensor, the data itself detected by the at least one sensor, data obtained by processing the data detected by the at least one sensor, and data generated using the data detected by the at least one sensor and data other than the data detected by the at least one sensor or data obtained by converting a format or the like of the data. The word “data” is a subordinate concept of the word “information” and indicates information that can be a target of processing by a computer.

As shown in FIG. 3, a plurality of (N) log data lists 3411, 3412, and the like are stored in the storing unit 34 of the server 4. The log data lists 3411, 3412, and the like are log data lists individually uploaded from a plurality of users registered in the server 4.

For example, log data (log data concerning life and log data concerning exercise) of a user allocated with a user ID “0001” is accumulated in the log data list 3411.

For example, log data (log data concerning life and log data concerning exercise) of a user allocated with a user ID “0002” is accumulated in the log data list 3412.

When receiving an upload request, log data (log data concerning life and log data concerning exercise), and a user ID via the communication unit 27 of the information terminal 2 used by a registered user, the network 3, and the communication unit 32 of the server 4, the processing unit 31 of the server 4 adds the received log data to a log data list corresponding to the user ID among the log data lists 3411, 3412, and the like stored in the storing unit 34. Note that, when course data (explained below) is included in the received log data, the processing unit 31 of the server 4 registers the course data in a database 350 of the storing unit 34. Details of the database 350 are explained below.

When receiving an download request, log data (log data concerning life and log data concerning exercise), and a user ID via the communication unit 27 of the information terminal 2 used by a registered user, the network 3, and the communication unit 32 of the server 4, the processing unit 31 of the server 4 reads out all or a part of log data lists corresponding to the user ID among the log data lists 3411, 3412, and the like stored in the storing unit 34 and transmits the log data lists to the information terminal 2 via the communication unit 32, the network 3, and the communication unit 27.

### 1-8. Overview of Course Recommendation Processing by the Server

Prior to exercise (training), the user operates the information terminal 2 to access the server 4 and transmits a generation request for a recommended course and a user ID to the server 4.

At this point, the processing unit 21 of the information terminal 2 acquires information (described below) necessary for generation of a recommended course and transmits the information to the server 4 together with the generation request for a recommended course and the user ID. The transmission of the information from the processing unit 21 of the information terminal 2 to the server 4 is performed via the communication unit 27, the network 3, and the communication unit 32 of the server 4. The transmission of the information from the processing unit 31 of the server 4 to the information terminal 2 is performed via the communication unit 32, the network 3, and the communication unit 27 (the same applies below).

The information necessary for generation of a recommended course is, for example, (i) the position of the user at the present point in time, (ii) log data concerning life of the user in a predetermined period such as the latest 24 hours (an example of time before the start of an activity), and (iii) log data concerning exercise of the user in a predetermined period such as the latest one month (an example of the time before the start of an activity).

The processing unit 120 of the electronic device 1 or the processing unit 21 of the information terminal 2 can generate the position of the user on the basis of positioning data output by the GPS sensor 110 of the electronic device 1. The positioning data and the position of the user are transmitted from the electronic device 1 to the information terminal 2 in a predetermined format via the communication unit 190 of the electronic device 1 and the communication unit 22 of the information terminal 2 at appropriate timing. When a GPS sensor (not shown in the figure) is mounted on the information terminal 2, the processing unit 21 of the information terminal 2 can also generate the position of the user on the basis of an output of the GPS sensor (not shown in the figure). When log data concerning life in a predetermined period and latest log data concerning exercise in the predetermined period are already uploaded from the information terminal 2 to the server 4, it is unnecessary to transmit the log data from the information terminal 2 to the server 4 again.

The processing unit 31 of the server 4 refers to a log data list corresponding to a user ID of the user and acquires physical condition information (a fatigue degree) concerning a physical condition of the user before the start of training on the basis of log data concerning life of the user and log data concerning exercise of the user. The processing unit 31 determines, on the basis of the physical condition information (the fatigue degree), a course of training suitable for the user at the present point in time and an event (an example of a type of training) of training (an example of an activity) suitable for the user. In the following explanation, the determined course (an example of a recommended route) is referred to as “recommended course” and the determined event is referred to as “recommended event” or “recommended training event”.

For example, the processing unit 31 of the server 4 executes course recommendation processing explained below and determines a recommended course and a recommended event to the user on the basis of the position of the user at the present point in time, weather information (provided from a weather server) of an area to which the position belongs, the latest log data (stored in the log data list corresponding to the user ID) of the user, the database 350, and the like. The processing unit 31 of the server 4 transmits information concerning the recommended course and the recommended event to the information terminal 2 in a predetermined format via the communication unit 32, the network 3, and the communication unit 27. The display unit 25 of the information terminal 2 displays the received information in an appropriate format. That is, the processing unit 31 of the server 4 presents the recommended course and the recommended event to the user via the information terminal 2. Note that the number of recommended courses and the like generated by the server 4 may be one or may be two or more.

The weather information used in the course recommendation processing is, for example, weather information temporarily stored in the storing unit 34 of the server 4 and is the latest weather information appropriately provided from the weather server (not shown in the figure) connected to the network 3. Note that the processing unit 31 of the server 4 receives weather information of a necessary area from the weather server according to necessity or periodically. The “necessary area” is an area to which the position of the user who issues the generation request for a recommended course belongs.

The processing unit 31 of the server 4 may present a target of training to the user together with the recommended course and the recommended event. The target of the training is a target of performance of the user in a process of the training and is, for example, targets of moving speed, targets of a moving time, targets of a heart rate, and the like in sections of the recommended course. Note that the target is desirably determined from a physical condition (a physical fatigue degree or a psychological fatigue degree) at the present point in time of the user, a physical or psychological tendency (type) of the user estimated from log data of the user, user body data (physique and age) of the user, and the like. Note that the “section” does not always have to coincide with the “lap section” (the same applies below).

### 1-9. Navigation Function of the Electronic Device

The user operates the information terminal 2 prior to the training and transfers the information concerning the recommended course and the recommended event from the information terminal 2 to the electronic device 1. The transfer of the information from the information terminal 2 to the electronic device 1 is performed via the communication unit 22 of the information terminal 2 and the communication unit 190 of the electronic device 1. The transfer of the information from the electronic device 1 to the information terminal 2 is performed from the communication unit 190 of the electronic device 1 in a predetermined format via the communication unit 22 of the information terminal 2 (the same applies below). Note that the recommended course is an example of a recommended route.

The user operates the operation unit 150 of the electronic device 1, selects a course and an event in which the user desires to perform training out of two or more recommended courses, and starts the training according to the selected course and the selected event. Information concerning the selected course and the selected event is used for a navigation function (explained below) during the training.

The user may manually input the course and the event selected by the user to the electronic device 1. The manual input may be omitted. However, when the input is omitted, in principle, when the user starts the training, the user operates the operation unit 150 of the electronic device 1 and inputs a notification to the effect that the training is started to the electronic device 1. When the user ends the training, the user operates the operation unit 150 of the electronic device 1 and inputs a notification to the effect that the training is ended to the electronic device 1.

When the input by the user is omitted, after the training start (during the training) or after the training end, the user may input a course and an event in which the user actually performs the training or the electronic device 1 may determine the course and the event. The information terminal 2 can also perform the determination. In that case, log data is sequentially transferred to the information terminal 2 during the training. The server 4 can also perform the determination. In that case, the log data is transferred from the electronic device 1 to the server 4 via the information terminal 2 after the end of the training.

The determination of the course is performed, for example, on the basis of the position of the user at a start point in time (in a predetermined period in the beginning) during the training. The determination of the event is performed, for example, on the basis of changes in the position (including altitude) of the user at points in time during the training. The following explanation is based on the premise that the electronic device 1 performs the determination of the course in the beginning of the training and the electronic device 1 sequentially performs the determination of the event, for example, in the process of the training.

The processing unit 120 of the electronic device 1 sequentially displays, during the training, a course adopted by the user and the present position of the user on the display unit 170 to thereby navigate the user (a navigation function). The processing unit 120 may execute, during the training, event determination processing and sequentially display a determined event on the display unit 170. The processing unit 120 may execute off-course determination processing explained below. When the present position of the user deviates from the course (goes off course), the processing unit 120 may notify the user to that effect via the display unit 170 or the sound output unit 180.

The processing unit 120 of the electronic device 1 develops the life logger function and the performance monitor function even during the training and continues the recording of log data concerning life of the user and recording of log data concerning exercise of the user.

The processing unit 120 of the electronic device 1 acquires, during the training, physical condition information concerning a physical condition of the user on the basis of at least one of the log data concerning life and the log data concerning exercise. When detecting on the basis of the physical information that the physical condition of the user is bad (deteriorated), the processing unit 120 notifies the user to that effect.

The processing unit 120 of the electronic device 1 detects, during the training, on the basis of the log data concerning exercise, a training event performed by the user. When the detected training event is different from a scheduled training event, the processing unit 120 notifies the user to that effect. Note that the notification from the electronic device 1 to the user is performed via the display unit 170 and the sound output unit 180 (the same applies below).

For example, during the training, the processing unit 120 of the electronic device 1 can monitor a heart rate of the user on the basis of an output of the pulse sensor 115, determine whether the pulse rate deviates from a proper range (a proper zone), and, when the heart rate deviates from the proper range, determine that the physical condition of the user is bad. The processing unit 120 of the electronic device 1 can calculate a proper zone for the user at the present point in time, for example, on the basis of sensing data output by one or two or more sensors (outputs of the sensors) other than the pulse sensor 115, the user body data stored in the storing unit 130, and the log data of the user.

The processing unit 120 of the electronic device 1 may correct (change), during the training, a recommended course according to weather information of an area to which the present position belongs, traffic information of the area, and the like. Note that the traffic information can be captured into the electronic device 1 via a not-shown traffic server, the server 4, the network 3, and the information terminal 2. The weather information can be captured into the electronic device 1 via the not-shown weather server, the server 4, the network 3, and the information terminal 2.

The processing unit 120 of the electronic device 1 can review a recommended course during the training. The review may be performed every time the user reaches determined several way points (a plurality of representative positions forming a course) such as intersections in the course. The processing unit 120 of the electronic device 1 determines presence or absence of necessity of the review when a way point is close. When determining that the review is necessary, the processing unit 120 notifies the user to that effect with vibration or the like beforehand and executes the course recommendation processing. The processing unit 120 determines that the review is necessary when a change in a situation (a change in the physical condition of the user, a change in the air pressure, etc.) is equal to or larger than a fixed level. Otherwise, the processing unit 120 determines that the review is unnecessary. The course recommendation processing is the same as, for example, the course recommendation processing executed by the processing unit 31 of the server 4. Details of the course recommendation processing are explained below.

However, a storage capacity of the storing unit 130 of the electronic device 1 is smaller than a storage capacity of the storing unit 34 of the server 4. Therefore, the processing unit 120 of the electronic device 1 desirably downloads, for example, course data concerning several courses in a limited area near a training start point from the server 4 in advance via the information terminal 2 and executes the course recommendation processing on the basis of the downloaded course data. Specifically, the processing unit 120 may transmit search conditions including position information of the electronic device to the server 4 via the information terminal 2. The server 4 may acquire course data matching the search conditions from the database 350. The electronic device 1 may download the acquired course data. The processing unit 120 of the electronic device 1 desirably downloads weather information and traffic information in the limited area from the server 4 via the information terminal 2, for example, every time the user reaches a way point.

The processing unit 120 of the electronic device 1 executes off-course determination processing explained below during the training. For example, when an actual moving track of the user deviates from the recommended course or when a moving direction of the user is opposite to the recommended course, the processing unit 120 may notify the user to that effect.

As explained above, the system determines a recommended course on the basis of a physical condition of the user before training and updates the recommended course according to the physical condition of the user during the training. Therefore, it is possible to recommend a course with a large load (a course with a large burden) when the physical condition of the user is good (e.g., a fatigue degree is low) and recommend a course with a small load (a course with a small burden) when the physical condition is bad (e.g., the fatigue degree is high). By taking into account the physical condition (the fatigue degree) of the user in this way, it is possible to expect improvement of the quality of the training and a reduction of risks of injury, accidents, and the like.

Note that course data of a course in which the user actually moves (position coordinates of posit ions on the course, an event of training actually performed in the course, etc.) is uploaded to the server 4 in a predetermined format via the electronic device 1 and the information terminal 2 when the user permits the upload. The processing unit 31 of the server 4 registers the course data uploaded from the information terminal 2 in the database 350 of the storing unit 34. If the server 4 collects course data from a large number of users in this way, it is possible to enhance contents of the database 350.

### 1-10. Display Screen

### (1) Display of a Recommended Course

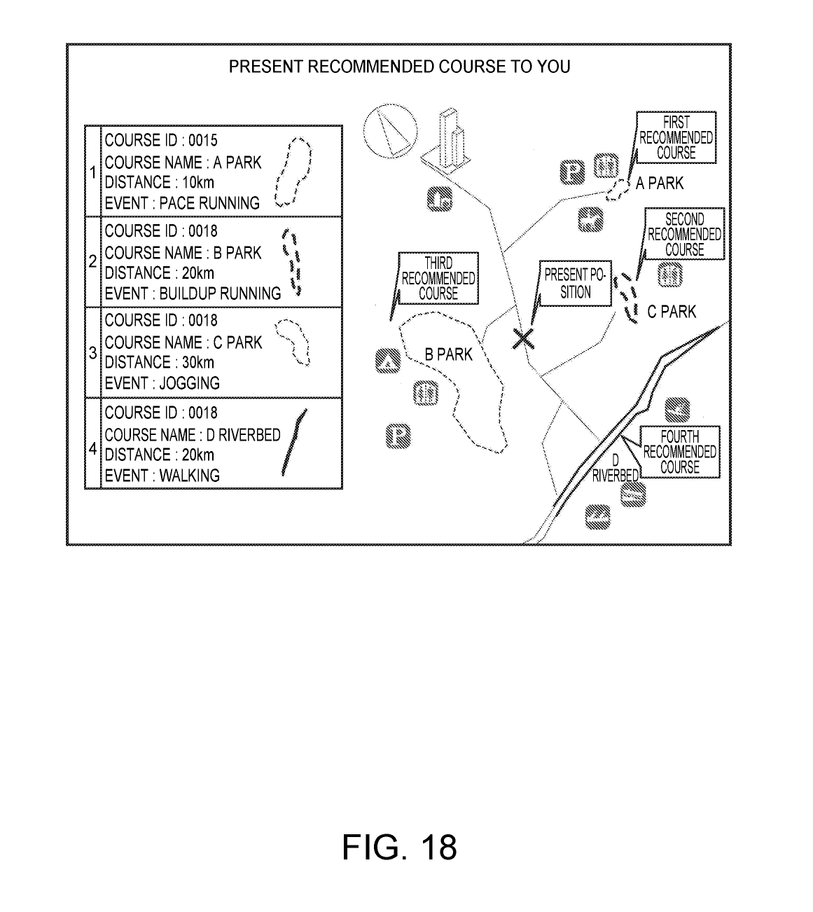

In this system, when the display unit 25 of the information terminal 2 or the display unit 170 of the electronic device 1 displays a recommended course, the display unit 25 or the display unit 170 desirably displays a map and summary information (a distance of the course, a scheduled required time, an elevation difference, etc.) related to the recommended course (see FIG. 18, etc.). Further the display unit 25 or the display unit 170 may display a sunrise time and a sunset time or display, for example, the remaining time until the sunset when the present time is the evening. The display unit 25 or the display unit 170 may display weather information such as weather and temperature related to the recommended course. When there are a plurality of recommended courses, the display unit 25 or the display unit 170 desirably scores the plurality of recommended courses and displays the recommended courses in the order of scores (note that the score is an example of a degree of recommendation or an indicator indicating the recommendation degree). When the display unit 25 or the display unit 170 displays the plurality of recommended courses, it is desirable to configure a user interface of the information terminal 2 or the electronic device 1 such that the user can select a desired course out of the plurality of recommended courses (see FIG. 23, etc.). Note that details of various display screens are explained below.

### (2) Display of a Training Event

In this system, the display unit 25 of the information terminal 2 and the display unit 170 of the electronic device 1 can display a recommended event together with the recommended course (see FIG. 18, etc.). Events include pace running, interval running, buildup running, LSD (long slow distance), undulation running (cross country), jogging, and walking. A recommended event displayed together with a certain recommended course means one or two or more training events suitable for the recommended course. This is because, since an undulation distribution, the number of signals, a distance, steepness of a curve, a state of the earth's surface (sidewalk, soil, tile, stone pavement, asphalt, or gravel road) and the like are different depending on a course, there are training events suitable for (training events unsuitable for) respective courses. Therefore, when selecting a course, the user can select a training event together with the course. Therefore, it is possible to further improve the quality of training than when the user selects only the course. Note that details of various display screens are explained below.

### (3) Display of a Schedule and an Achievement

In this system, after the end of training, the display unit 25 of the information terminal 2 and the display unit 170 of the electronic device 1 can also display a course and an event selected by the user as a “schedule” and display a course and an event actually adopted by the user as an “achievement” (see FIG. 35, etc.). The user can utilize the displayed schedule and the displayed achievement as materials for reviewing the training performed by the user. Note that details of various display screens are explained below.

### 1-11. Self-Evaluation of a Physical Condition by the User

### 1-11-1. Input Screen by Slide Bars

This system may introduce a mechanism for introducing self-evaluation of a physical condition by the user himself/herself prior to training and grasp the physical condition of the user taking into account subjective elements as well.

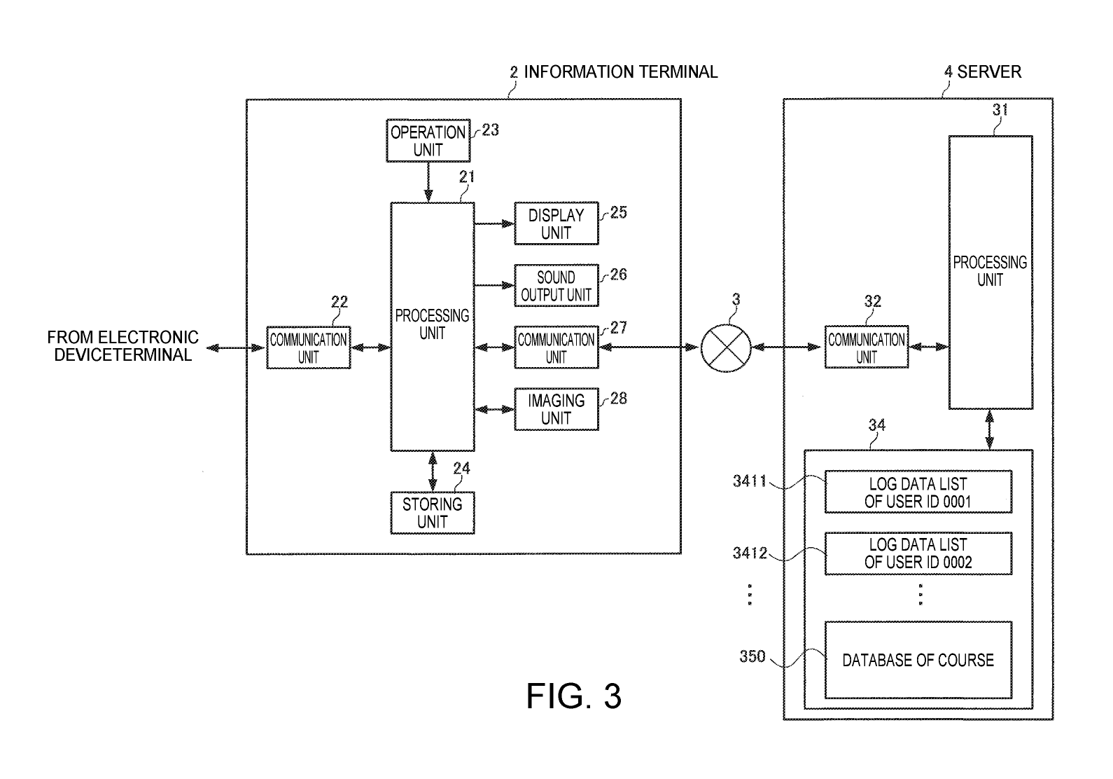

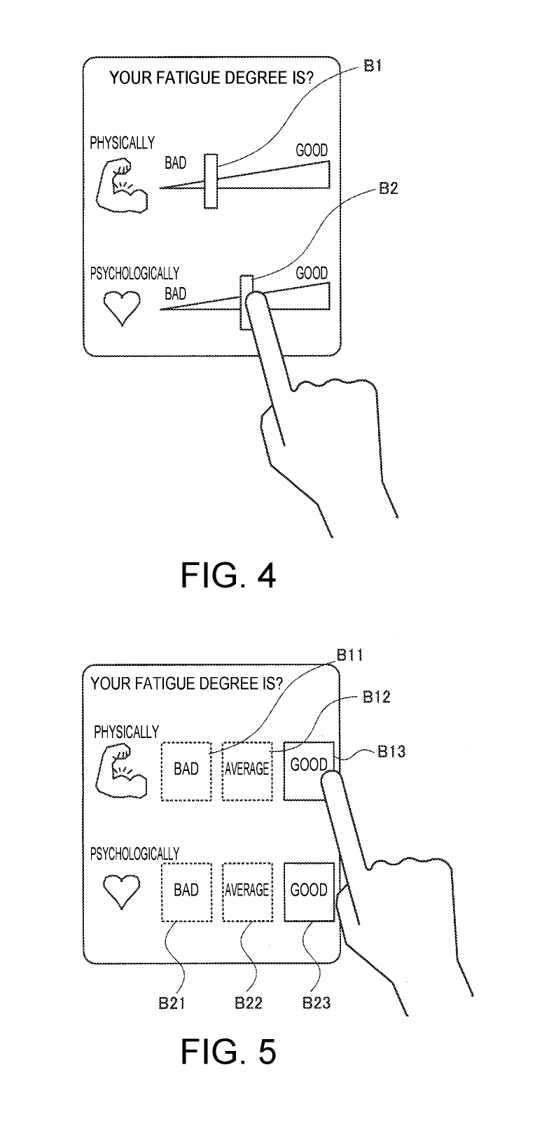

For example, the display unit 25 (assumed to be a touch panel display) of the information terminal 2 displays an input screen shown in FIG. 4 and urges the user to input self-evaluation. In an example shown in FIG. 4, a slide bar B1 for the user to input a physical fatigue degree (an example of information concerning a physical state of the user) and a slide bar B2 for the user to input a psychological fatigue degree (an example of information concerning a psychological state of the user) are displayed. The user can adjust slide positions of the slide bars B1 and B2 by touching the slide bars B1 and B2 of the input screen with a finger and then sliding the slide bars B1 and B2 to the left and right.

The processing unit 21 of the information terminal 2 detects the slide positions of the slide bars B1 and B2 in cooperation with the touch panel display (the display unit 25). The processing unit 21 detects a value corresponding to the slide position of the slide bar B1 as a physical fatigue degree declared by the user and detects a value corresponding to the slide position of the slide bar B2 as a psychological fatigue degree declared by the user. Consequently, the user can input a physical fatigue degree and a psychological fatigue degree felt by the user to the information terminal 2 (the fatigue degrees are examples of physical condition information based on information input by the user).

Thereafter, when the user taps a not-shown decision button, the processing unit 21 of the information terminal 2 transmits a value of a psychological fatigue degree and a value of a physical fatigue degree at a point in time of the tapping to the server 4 together with the present time. The value of the psychological fatigue degree and the value of the physical fatigue degree are used for the course recommendation processing by the server 4.

This is because, in general, since each user feels fatigue differently, a divergence is likely to occur between a psychological fatigue degree and a physical fatigue degree estimated on the basis of log data and a psychological fatigue degree and a physical fatigue degree actually felt by the user.

Note that the processing unit 21 of the information terminal 2 may transmit information indicating the position of the user to the server 4 together with the values of the fatigue degrees. The information indicating the position of the user can be acquired on the basis of positioning data output by the GPS sensor 110.

### 1-11-2. Input Screen by Stepwise Evaluation

Note that the display unit 25 of the information terminal 2 may display an input screen shown in FIG. 5 as the input screen. In an example shown in FIG. 5, the user can select one of fatigue degrees of “bad”, “average”, and “good” in three stages as a physical fatigue and can select one of fatigue degrees “bad”, “average”, and “good” in three stages as a psychological fatigue degree.

Incidentally, on the input screen shown in FIG. 5, a select button B11 to which a character image of “bad” is given, a select button B12 to which a character image of “average” is given, and a select button B13 to which a character image of “good” is given are disposed side by side as buttons for selecting a physical fatigue degree.

On the input screen shown in FIG. 5, a select button B21 to which a character image of “bad” is given, a select button B22 to which a character image of “average” is given, and a select button B23 to which a character image of “good” is given are disposed side by side as buttons for selecting a psychological fatigue degree.

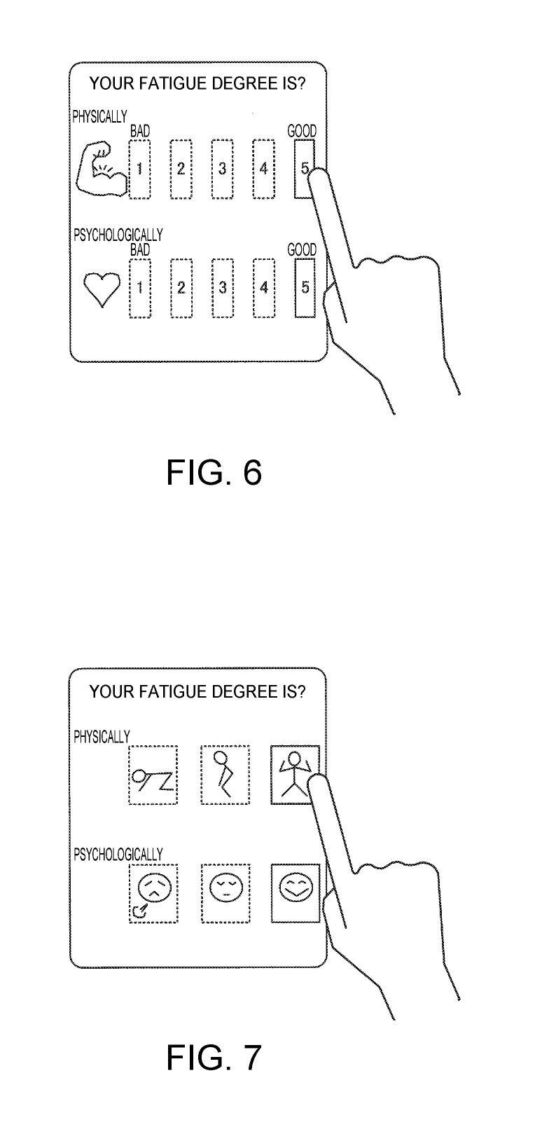

The display unit 25 of the information terminal 2 may display an input screen shown in FIG. 6 as the input screen. In an example shown in FIG. 6, the user can select one of fatigue degrees “1”, “2”, “3”, “4”, and “5” in five stages as a physical fatigue degree and can select one of fatigue degrees “1”, “2”, “3”, “4”, and “5” in five stages as a psychological fatigue degree.

### 1-11-3. Input Screen by Icons

The display unit 25 of the information terminal 2 may display an input screen shown in FIG. 7 as the input screen. In an example shown in FIG. 7, fatigue degrees in three stages are represented by icons. The user can input a fatigue degree by selecting an icon.

Incidentally, on the input screen shown in FIG. 7, icons representing physical fatigue degrees using poses of a body are adopted and icons representing psychological fatigue degrees using facial expressions of a person are adopted. If such icons are used, it is possible to smoothly cause the user to self-declare a fatigue degree without using language.

### 1-11-4. Other Input Screens

Note that the display unit 25 of the information terminal 2 may display both of the slide bars (FIG. 4) and the icons (FIG. 7) on one input screen. In that case, the display unit 25 may change the icons in association with the slide positions of the slide bars.

### 1-12. Principle of the Course Recommendation Processing

In this system, a physical fatigue degree and a psychological fatigue degree are distinguished from each other because an event suitable for the user is different depending on a ratio of the physical fatigue degree and the psychological fatigue degree even if a fatigue degree is the same.

Therefore, the processing unit 31 of the server 4 classifies combinations of physical fatigue degrees and psychological fatigue degrees into four categories described below and determines a recommended event for each of the categories. An example of four categories (1) to (4) and recommended events is explained below.

(1) When both of a physical fatigue degree and a psychological fatigue degree of the user are low, a relatively hard event (buildup running, interval running, etc.) is selected determined a recommended event.

(2) When both of the physical fatigue degree and the psychological fatigue degree of the user are high, an event with a relatively low load (slow short-distance running, rest, etc.) is determined as a recommended event.

(3) When the physical fatigue degree of the user is high and the psychological fatigue degree of the user is low, an event with which the user can easily recover from physical fatigue (slow pace running, etc.) is determined as a recommended event.

(4) When the physical fatigue degree of the user is low and the psychological fatigue degree of the user is high, an event with which the user can easily recover from psychological fatigue (LSD, etc.) is determined as a recommended event. The LSD is an event in which the user can relax and run for a long time with an instantaneous load reduced.

The processing unit 31 of the server 4 determines a recommended course for the user on the basis of the recommended event determined by the policies (1) to (4), the present position of the user, weather information of an area to which the present position belongs, traffic information of the area, and the database 350.

### 1-13. Physical Condition Evaluation by the Server (Physical Fatigue)

For example, the processing unit 31 of the server 4 acquires, on the basis of log data (mainly acceleration data and data of a heart rate) in the latest twenty-four hours, states (sleeping, standing, stationary, walking, and stepping the stairs) of the user at respective points in time in the twenty-four hours and heart rates of the user at the respective points in time in the twenty-four hours.

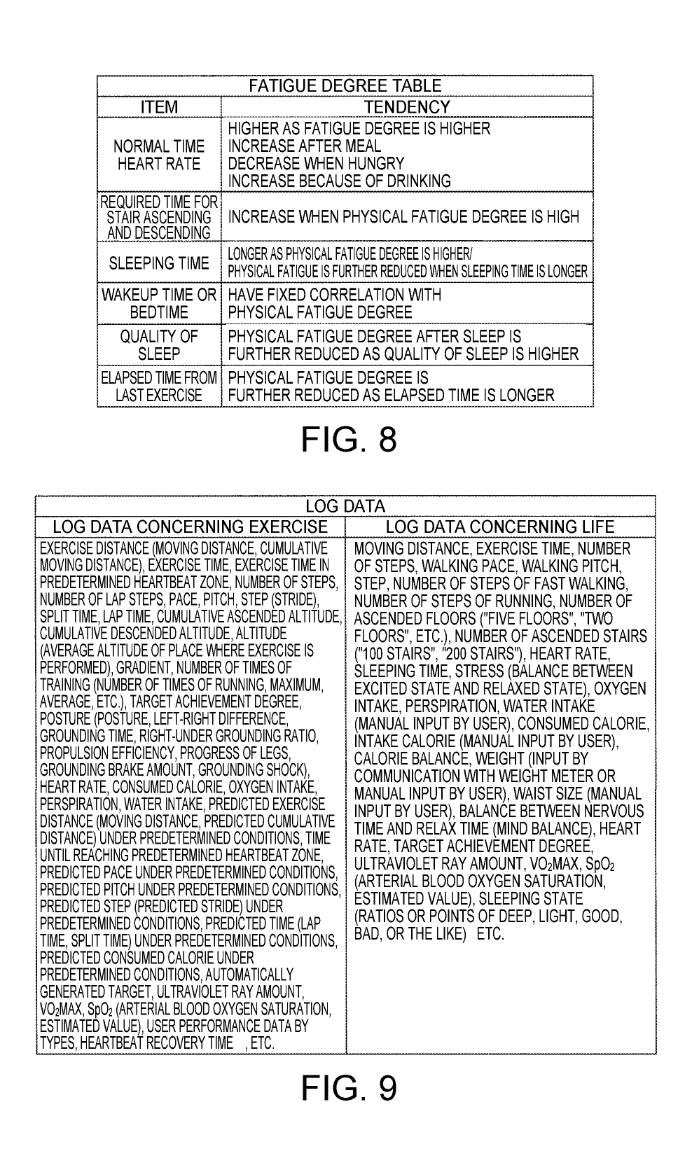

The processing unit 31 of the server 4 calculates a fatigue degree at the present point in time (before training) of the user by referring to, for example, a fatigue degree table shown in FIG. 8 according to a state of the user and a heart rate of the user.

The fatigue degree table shown in FIG. 8 is stored in, for example, the storing unit 341 of the server 4 in advance. In FIG. 8, a fatigue degree is represented by word. However, an actual fatigue degree table is configured as, for example, a table for calculating a physical or psychological fatigue degree as a numerical value according to a combination of a heart rate of the user and a state of the user.

The processing unit 31 calculates, for example, a physical or psychological fatigue degree in every one hour, for example, on the basis of log data in the latest twenty-four hours and the fatigue table and sets a total of the calculated fatigue degrees (a total fatigue degree) as a fatigue degree at the present point in time.

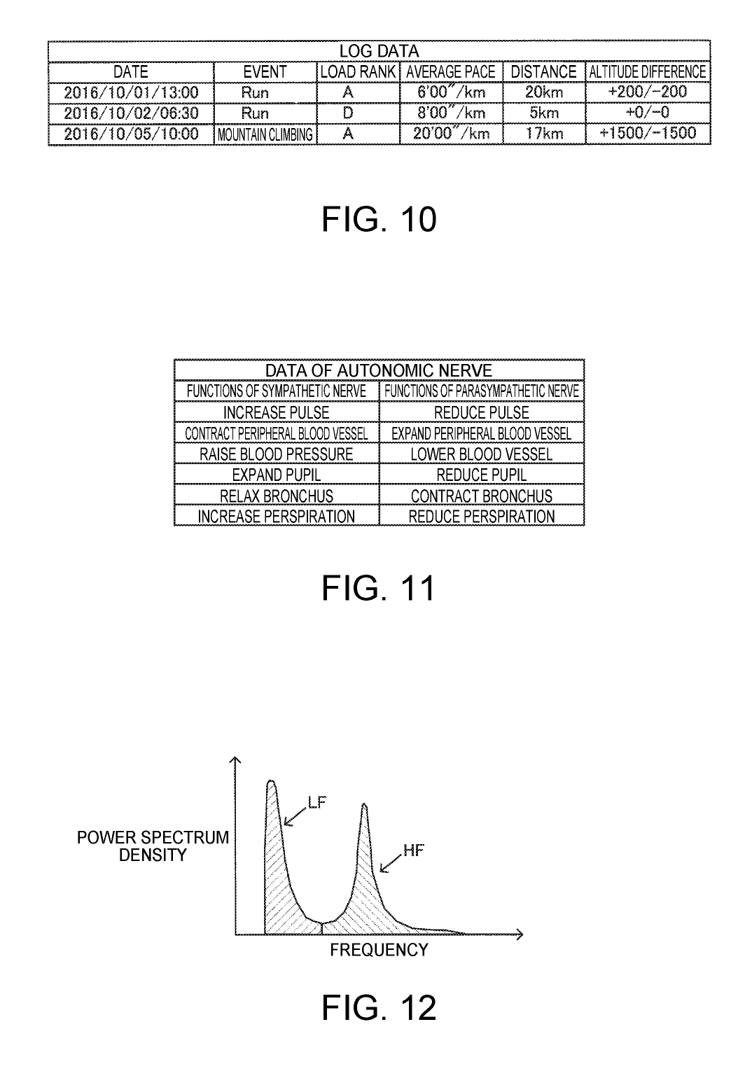

The processing unit 31 estimates, on the basis of load ranks given to the log data in the latest one month, a physical fatigue degree remaining without being eliminated up to the present point in time. An example of log data given to load ranks is shown in FIG. 10. The load ranks are given to respective training events included in the log data. The load rank is a value relatively representing the magnitude of a load (leading to a fatigue degree) given to the user by a training event. In particular, a higher load rank is given to a training event in which a physical fatigue degree is less easily eliminated even if time elapses. The processing unit 31 estimates, referring to the load ranks, a larger physical fatigue degree remaining without being eliminated up to the present point in time as there are a larger number of events with high load ranks and as a time consumed for the events with the high load ranks is longer. In this way, the processing unit 31 can highly accurately calculate a fatigue degree of the user at the present point in time.

Note that the processing unit 31 gives the load rank to the log data (evaluates the load rank), for example, every time the log data is uploaded. The processing unit 31 may set references of the load ranks for each of users or may set the references of the load ranks in common for all the users.

For example, the processing unit 31 calculates a personal best (a personal best pace) concerning the log data included in the log data list of the user. In this case, the processing unit 31 gives a higher load rank to a pace having a smaller difference from the personal best pace among paces included in the log data list and writes the load rank in a relevant part of the log data list (see FIG. 10). In the example shown in FIG. 10, the load ranks are represented by alphabets such as A, B, and C. In the example shown in FIG. 10, A means a high load. A rank A and a rank D are displayed.

The processing unit 31 may determine, for example, on the basis of the log data concerning life included in the log data list of the user, whether the user drank in the previous day of the present point in time and reflect a result of the determination on a fatigue degree of the user at the present point in time. The processing unit 31 can determine whether the user drank according to, for example, whether a heart rate during sleep at night in the previous day is extremely high compared with an average heart rate (e.g., an average heart rate in the latest one month) during sleep of the user (whether the heart rate exceeds a threshold). The processing unit 31 can determine a sleeping period on the basis of the log data concerning life. For example, the processing unit 31 only has to detect, on the basis of acceleration data included in log data at respective times at night, whether the user was in a resting state at the respective times and determine, as the sleeping period, a continuous period in which the user is detected as being in the resting state, the period having length equal to or larger than a threshold. Note that, when information concerning the sleeping period is already included in the log data received by the server 4, the processing unit 31 of the server 4 can omit the determination of the sleeping period.

### 1-14. Physical Condition Evaluation by the Server (Psychological Fatigue)

In order to calculate a psychological fatigue degree of the user at the present point in time (before training), for example, the processing unit 31 of the sever 4 analyzes data of a pulse wave included in log data concerning life in the latest twenty-four hours and calculates a balance (a mind balance) between the sympathetic nerve and the parasympathetic nerve. Note that, when information concerning the mind balance is already included in the log data received by the server 4, the processing unit 31 of the server 4 can omit the calculation of the mind balance.

It is said that the mind balance has a proper value (an ideal balance) for each user and for each state (a sleeping or awake state) of the user and the mind balance further tends to deviate from the ideal balance as a psychological fatigue degree of the user is higher.

Therefore, the processing unit 31 calculates, for example, on the basis of log data (in particular, log data indicating a state of the user) of the user in the latest twenty-four hours and the user body data of the user, an ideal balance of the user at every time within the latest twenty-four hours. The processing unit 31 calculates, at every time, a degree of deviation between a mind balance (a measured mind balance) included in the log data of the user and the ideal balance. The processing unit 31 calculates, as a psychological fatigue degree of the user at the present point in time, a value obtained by multiplying an average of deviation degrees at respective times with a given coefficient. Note that details of deviation-degree calculation processing are explained below.

As a method of calculating a mind balance from pulse data included in log data, there is RRI (R-R Interval). For example, the processing unit 31 performs statistical processing of a temporal change curve (a pulse wave) of the pulse data in time series using FFT (Fast Fourier Transform) to calculate a power spectrum in a frequency domain and calculates, as the mind balance, a ratio of a low-frequency component LF and a high-frequency component HF appearing in the power spectrum. FIG. 12 represents power spectra of the LF and the HF as a schematic graph.

Note that the method of calculating the mind balance on the basis of an output (pulse data) of the pulse sensor 115 is explained above. However, the processing unit 31 may calculate the mind balance on the basis of outputs of other sensors. FIG. 11 is general data indicating how the sympathetic nerve and the parasympathetic nerve affect the body of the user. As shown in FIG. 11, the mind balance affects body functions other than a pulse. Therefore, the processing unit 31 can calculate the mind balance on the basis of outputs of sensors other than the pulse sensor 115, the data shown in FIG. 11, or a calculation formula or a table calculated from the data.

### 1-15. Comprehensive Body Condition Evaluation by the Server

The processing unit 31 of the server 4 calculates a comprehensive fatigue degree using both of a fatigue degree declared by the user and a fatigue degree calculated by the processing unit 31.

Note that, when the mind balance calculated on the basis of the RRI deviates from the ideal mind balance, the processing unit 31 of the server 4 may calculate a difference between the calculated mind balance and the ideal mind balance. The processing unit 31 may add the calculated difference to the log data list of the user as a stress indicator.

### 1-16. Deviation-Degree Calculation Processing by the Electronic Device

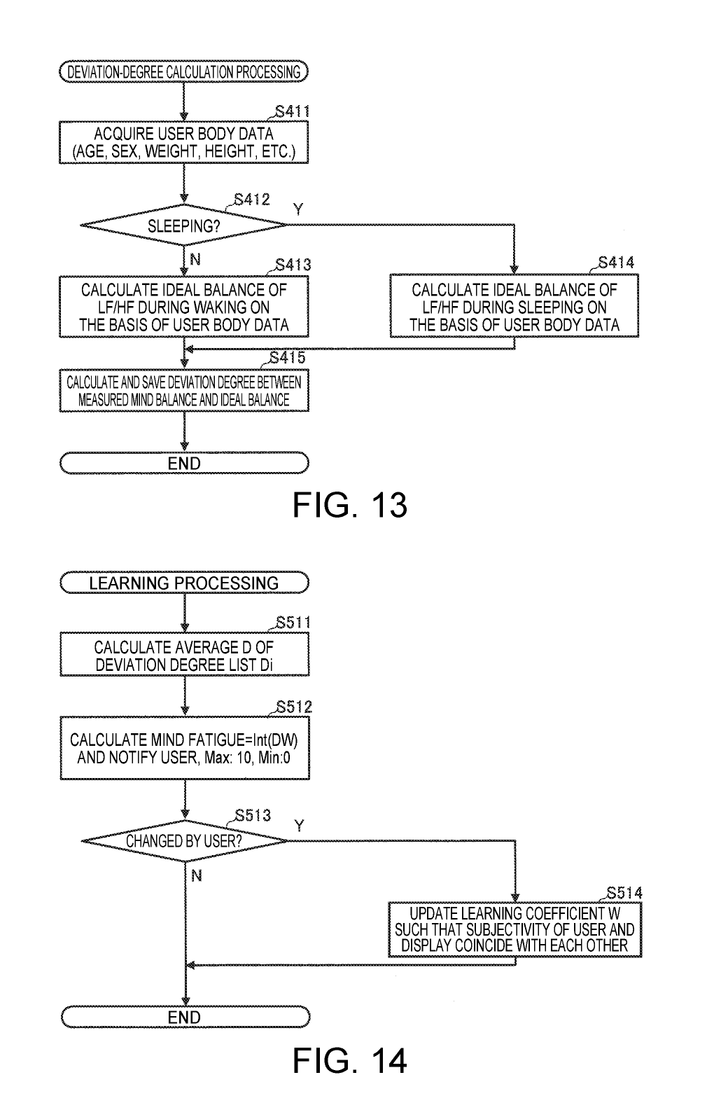

FIG. 13 is a flow of the deviation-degree calculation processing.

In the above explanation, the processing unit 31 of the server 4 executes the processing for calculating a deviation degree between the mind balance of the user and the ideal mind balance. However, the processing unit 120 of the electronic device 1 may execute the deviation-degree calculation processing. That is, the processing unit 120 of the electronic device 1 may calculate deviation degrees at respective times during life of the user, include the deviation degree at every time in log data, and upload the deviation degree to the server 4 via the information terminal 2.

It is assumed that the deviation-degree calculation processing is executed by the processing unit 120 of the electronic device 1. The flow of FIG. 13 is repeatedly executed periodically (e.g., every one minute) in a period in which the life logger function develops in the electronic device 1. Steps in FIG. 13 are explained below.

First, the processing unit 120 refers to the user body data stored in the storing unit 130 (S411). The user body data includes, for example, age, sex, weight, and height of the user.

Subsequently, the processing unit 120 determines on the basis of acceleration data output by the acceleration sensor 113 whether the user is sleeping (S412).

When determining that the user is not sleeping (N in S412), the processing unit 120 calculates an ideal mind balance during waking on the basis of the user body data (S413).

When determining that the user is sleeping (Y in S412), the processing unit 120 calculates an ideal mind balance during sleeping on the basis of the user body data (S414).

The processing unit 120 calculates, for example, on the basis of pulse data in a predetermined period including the present point in time, a mind balance of the user at the present point in time (or a certain point in time in the predetermined period) according to the method of the RRI, calculates a difference between the calculated mind balance and the ideal mind balance calculated in step S411 as a deviation degree, writes the deviation degree in the storing unit 130 together with time data, which is one of the log data concerning life, and ends the flow (S415).

### 1-17. Learning Processing by the Server

FIG. 14 is a flow of learning processing by the processing unit 31 of the server 4. Steps in FIG. 14 are explained below.

First, the processing unit 31 calculates, for example, an average D of a deviation degree list included in the log data of the latest twenty-four hours (S511). The deviation degree list included in the log data of the latest twenty-four hours means deviation degrees (time series data of the deviation degrees) at respective points in time in the latest twenty-four hours.

Subsequently, the processing unit 31 calculates, for example, a psychological fatigue degree according to a calculation formula of Int (DW), notifies the calculated fatigue degree to the user (e.g., displays any one of the input screens shown in FIGS. 4 to 7), and receives declaration of a fatigue degree (input of a fatigue degree) by the user (S512). However, in initial step S512, the processing unit 31 sets a coefficient W to an initial value (a default value) determined in advance. An operator “Int (A)” is an operator for converting “A” into an appropriate integer within a range of 0 to 10.

Subsequently, the processing unit 31 determines whether the fatigue degree declared by the user is different from the calculated fatigue degree, that is, the fatigue degree is changed by the user (S513). When the fatigue degree is changed (Y in S513), the processing unit 31 changes the coefficient W of the calculation formula such that the fatigue degree calculated by the calculation formula coincides with the declared fatigue degree and then ends the flow (S514).

On the other hand, when the fatigue degree declared by the user is not changed from the calculated fatigue degree (N in S513), the processing unit 31 ends the flow without changing the coefficient W of the calculation formula.

According to the learning processing explained above, the coefficient W of the calculation formula is periodically reviewed and appropriately corrected. Therefore, it is possible to bring the psychological fatigue degree calculated by the calculation formula close to a psychological fatigue degree felt by the user.

According to the learning processing, it is also possible to reflect a fatigue degree actually felt by user on determination of a recommended course and a recommended event.

For example, thereafter, when the psychological fatigue degree calculated by the calculation formula (i.e., the psychological fatigue degree included in the log data) is high (i.e., when the user strongly feels psychological fatigue), the processing unit 31 of the server 4 determines an event with a light load as a recommended event for the user and determines a course suitable for the event as a recommended course for the user. Note that details of the course recommendation processing are explained below.

On the other hand, when the psychological fatigue degree calculated by the calculation formula (i.e., the psychological fatigue degree included in the log data) is low (i.e., when the user feels little psychological fatigue), the processing unit 31 of the server 4 determines an event with a heavy load as a recommended event for the user and determines a course suitable for the event as a recommended course for the user. Note that details of the course recommendation processing are explained below.

### 1-18. Training Event

The processing unit 31 of the server 4 determines a recommended course for the user using the physical condition information of the user. In the following explanation, the processing unit 31 determines a training event suitable for the user (hereinafter referred to as “recommended training event” or “recommended event”) and determines a course suitable for the recommended event (a recommended course). It is assumed that several kinds of training involving movement in a course are assumed as training events performed by the user. As explained above, the physical condition information includes at least one of information concerning a psychological state (a psychological fatigue degree) of the user and information concerning a physical state (a physical fatigue degree) of the user.

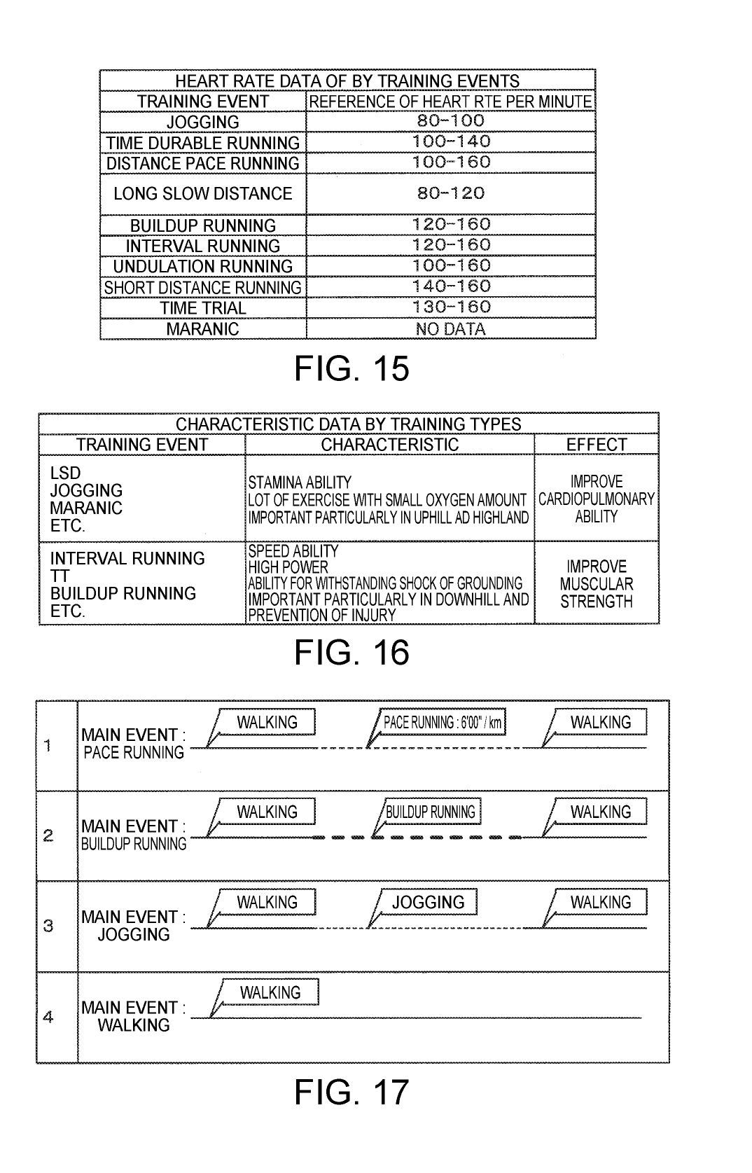

An example of training events (candidates of training events) that can be candidates of a recommended event is shown in FIG. 15. As shown in FIG. 15, examples of the candidates of the training events include jogging, time durable running, pace running, LSD (Long Slow Distance), buildup running, interval running, undulation running, short distance running, TT (Time Trial), maranic, and walking. Note that numerical values (references) of heart rates by events are shown in FIG. 15.

A table in which the training events that can be candidates of a recommended event are classified according to characteristics of the training events is shown in FIG. 16. That is, the training events can be classified into events for improving a cardiopulmonary ability and events for improving a speed ability. For example, LSD, jogging, and maranic belong to the events for improving the cardiopulmonary ability. Interval running, TT, and the buildup running belong to the events for improving the speed ability.

The processing unit 31 of the server 4 determines a recommended event for the user and determines a recommended course for the user taking into account a fatigue degree (a psychological fatigue degree and a physical fatigue degree) of the user and information shown in FIGS. 15 and 16.

For example, a table (not shown in the figure) in which combinations of psychological fatigue degrees and physical fatigue degrees and recommended events are associated is stored in the storing unit 34 of the server 4 in advance. The processing unit 31 of the server 4 determines a recommended event by referring to the table according to a psychological fatigue degree and a physical fatigue degree of the user. Note that the table is a table in which the four categories (1) to (4) and recommended events for the respective categories are associated.

The database 350 of a plurality of courses is stored in the storing unit 34 of the server 4. Therefore, the processing unit 31 of the server 4 determines a recommended course for the user by referring to the database 350 on the basis of the determined recommended event and the position of the user. For example, a course, the distance of which from the position of the user is within a predetermined distance range and which is suitable for performing the recommended event, is determined as a recommended course for the user.

The processing unit 31 of the server 4 generates information (browsing data) indicating the determined recommended event and the determined recommended course, transmits the information to the information terminal 2, and causes the display unit 25 of the information terminal 2 to display the recommended event and the recommended course. Note that the display of the recommended event and the display of the recommended course may be performed on separate screens or may be performed on the same screen.

### 1-19. Display Screen for Recommended Events (List Display)

FIG. 17 is a diagram for explaining an example of a display screen for recommended events.

On the display screen, a plurality of recommended events are arrayed side by side in a predetermined direction (in FIG. 17, a direction recognized as the up-down direction by the user) such that the user can view the recommended events at a glance.

In the example shown in FIG. 17, in several recommended events, an event (walking) of warming-up and an event (walking) of cool-down, which are effective when being performed together with the recommended events, are added before and after main recommended events. However, the addition of the events of the warming-up and the cool-down can also be omitted. Muscle training can also be added instead of the warming-up or the cool-down. Therefore, the example shown in FIG. 17 can also be referred to as a list of “recommended training menus”.

On the display screen shown in FIG. 17, a main recommended event of a recommended training menu displayed in a first stage is “pace running for 60′00″”, a main recommended event of a recommended training menu displayed in a second stage is “buildup running”, a main recommended event of a recommended training menu displayed in a third stage is “jogging”, and a main recommended event of a recommended training menu displayed in a fourth stage is “walking”.

Array order on the display screen of the plurality of recommended events is descending order of scores (an example of indicators indicating recommendation degrees). The scores of the recommended events are ranks, numerical values, or the like indicating suitability degrees (recommendation degrees) to the user. For example, the processing unit 31 of the server 4 calculates the scores on the basis of characteristics (FIG. 16) of the respective training events and the log data of the user.

On the display screen, recommended events different from one another are represented by curved line images (in FIG. 17, straight line images) different from one another. In the example shown in FIG. 17, the “pace running” is indicated by a broken line image having a standard line width, the “buildup running” is indicated by a broken line image having a line width larger than the standard, the “jogging” is indicated by a broken line image having a line width smaller than the standard, and the “walking” is indicated by a solid line image. Note that, in FIG. 17, the events are indicated by characters as well.

When the recommended events different from one another are displayed in visual representations different from one another (straight line images having line types and line widths different from one another) in this way, the user can intuitively recognize a current recommended event to the user and can easily compare two or more recommended events currently suitable for the user.

Note that, in the above explanation, the straight line images having the line types and the line widths different from one another are allocated to the recommended events different from one another. However, straight line images having line colors different from one another may be allocated to the recommended events different from one another. Straight line images that flash in patterns different from one another may be allocated to the recommended events different from one another. Straight line images having textures different from one another may be allocated to the recommended events different from one another. That is, as the visual representations for distinguishing the recommended events, the curved line images, at least one of the line colors, the line widths, the line types, the temporal change patterns, and the textures of which are different, can be adopted.

As the visual representations, the curved line images (in FIG. 17, the straight line images) extending in the lateral direction when viewed from the user are adopted in the above explanation. However, visual representations other than the simple curved line images, for example, visual representations such as a tube image, a block image, a rope image, a wire image, a ribbon image, an arrow mark, a block image row, and a mark row can also be adopted.

Note that, on the display screen, standard times or standard distances required for the recommended events may be reflected on the lengths of the visual representations (various images) on the display screen. In this case, the user can intuitively grasp references of times or distances required for the respective recommended events from the lengths of the visual representations (various images).

In the above explanation, the plurality of recommended events are simultaneously displayed on the one display screen. However, the plurality of recommended events may be sequentially (cyclically) displayed on the one display screen. In that case, the screen may be automatically switched at every fixed time (e.g., one second) or may be switched at timing when the user performs predetermined operation.

### 1-20. Display Screen for Recommended Courses (Map Display)

FIG. 18 is a diagram for explaining an example of a display screen for recommended courses.

In a predetermined region (in FIG. 18, a region on the left side when viewed from the user) of the display screen, respective overviews of a plurality of recommended courses are displayed side by side in a predetermined direction (in FIG. 18, the up-down direction when viewed from the user) such that the user can view the overviews at a glance.

Note that, in the example shown in FIG. 18, recommended events suitably performed in the plurality of recommended courses are given to the respective recommended courses. In the following explanation, the recommended course to which the recommended event is given is simply referred to as “recommended course” or “recommended course with the recommended event”.

On the display screen, a recommended course displayed in a first stage is an “A park” and a recommended event given to the recommended course is the “pace running”.

On the display screen, a recommended course displayed in a second stage is a “B park” and a recommended event given to the recommended course is the “buildup running”.

On the display screen, a recommended course displayed in a third stage is a “C park” and a recommended event given to the recommended course is the “jogging”.

On the display screen, a recommended course displayed in a fourth stage is a “D riverbed” and a recommended event given to the recommended course is the “walking”.

Array order on the display screen for the plurality of recommended courses is descending order of scores. The scores of the recommended events are scores indicating suitability degrees (recommendation degrees) to the user and are calculated by the processing unit 31 of the server 4. A specific example of a calculation formula of the scores is explained below.

On the display screen, the respective recommended courses are represented by curved line images indicating shapes of the courses.

On the display screen, the respective recommended courses are displayed in visual representations corresponding to recommended events that should be performed in the recommended courses. In the example shown in FIG. 18, a recommended course in which the “pace running” should be performed is indicated by a broken line image having a standard line width, a recommended course in which the “buildup running” should be performed is indicated by a broken line image having a line width larger than the standard, a recommended course in which the “jogging” should be performed is indicated by a broken line image having a line width smaller than the standard, and a recommended course in which the “walking” should be performed is indicated by a solid line image.

That is, in the example shown in FIG. 18, at least one recommended course includes a first recommended course (the A park) corresponding to the first training event (the pace running), a second recommended course (the B park) corresponding to a second training event (the buildup running) different from the first training event, a third recommended course (the C park) corresponding to a third training event (the jogging) different from the first and second training events, and a fourth recommended course (the D riverbed) corresponding to a fourth training event (the walking) different from the first to third training events.

The first recommended course (the A park) is indicated by a first visual representation (the broken line image having the standard line width) corresponding to the first training event. The second recommended course (the B park) is indicated by a second visual representation (the broken line image having the line width larger than the standard). The third recommended course (the C park) is indicated by a third visual representation (the broken line image smaller than the standard) corresponding to the third training event. The fourth recommended course (the D riverbed) is indicated by a fourth visual representation (the solid line image) corresponding to the fourth training event.

If the respective recommended courses are represented by the visual representations corresponding to the recommended events that should be performed in the recommended courses in this way, the user can visually grasp both of the recommended courses and the recommended events without relying on linguistic representations.

Note that, in the above explanation, the direct line images having the line types and the line width different from one another are given to the recommended events different from one another. However, straight line images having line colors different from one another may be allocated to the recommended events different from one another. Straight line images that flash in patterns different from one another may be allocated to the recommended events different from one another. Straight line images having textures different from one another may be allocated to the recommended events different from one another. That is, as the visual representations for distinguishing the recommended events, the curved line images, at least one of the line colors, the line widths, the line types, the temporal change patterns, and the textures of which are different, can be adopted.

As the visual representations, the curved line images are adopted in the above explanation. However, visual representations other than the simple curved line images, for example, visual representations such as a tube image, a block image, a rope image, a wire image, a ribbon image, an arrow mark, a block image row, and a mark row can also be adopted.

Note that, on the display screen, standard times or standard distances required for the respective recommended courses with the recommended events may be reflected on the sizes of the visual representations (various images) on the display screen. In this case, the user can intuitively grasp references of times or distances required for the respective recommended courses with the recommended events from the sizes of the visual representations (various images).

In the above explanation, the plurality of recommended courses are simultaneously displayed on the one display screen. However, the plurality of recommended courses may be sequentially (cyclically) displayed on the one display screen. In that case, the screen may be automatically switched at every fixed time (e.g., one second) or may be switched at timing when the user performs predetermined operation.

A map of an area to which the plurality of recommended course belong is displayed in a predetermined region (a region on the right side when viewed from the user) of the display screen shown in FIG. 18 in order to notify a positional relation and the like of the plurality of recommended courses to the user.

In the map, for example, the present position of the user and routes from the present position of the user to the plurality of recommended courses are displayed. In this case, when selecting one of the plurality of recommended courses as a course of training, the user can refer to distances and routes from the present position to the respective plurality of recommended courses. When selecting a course of training, the user can also refer to distances of the plurality of recommended courses (total lengths of the courses) on the map.

In the map, the respective plurality of recommended courses are indicated by visual representations corresponding to the recommended events given to the recommended courses. That is, in the map, the respective plurality of recommended courses are indicated by visual representations corresponding to the recommended events (visual representations corresponding to types of activities).

Therefore, the user can easily grasp, on the map, the recommended events given to the respective recommended courses.

Note that, in the map, besides the above, information related to training and information necessary for moving to courses are desirably described. Examples of the information include landmarks, rest rooms, showers, parking lots, bicycle parking lots, convenience stores, sports shops, drinking fountains, and rest areas. The processing unit 31 of the server 4 may select, according to at least one of recommended events and recommended courses that should be displayed on the map, information that should be displayed on the map.

### 1-21. Display Screen for Recommended Courses (Superimposed Display)

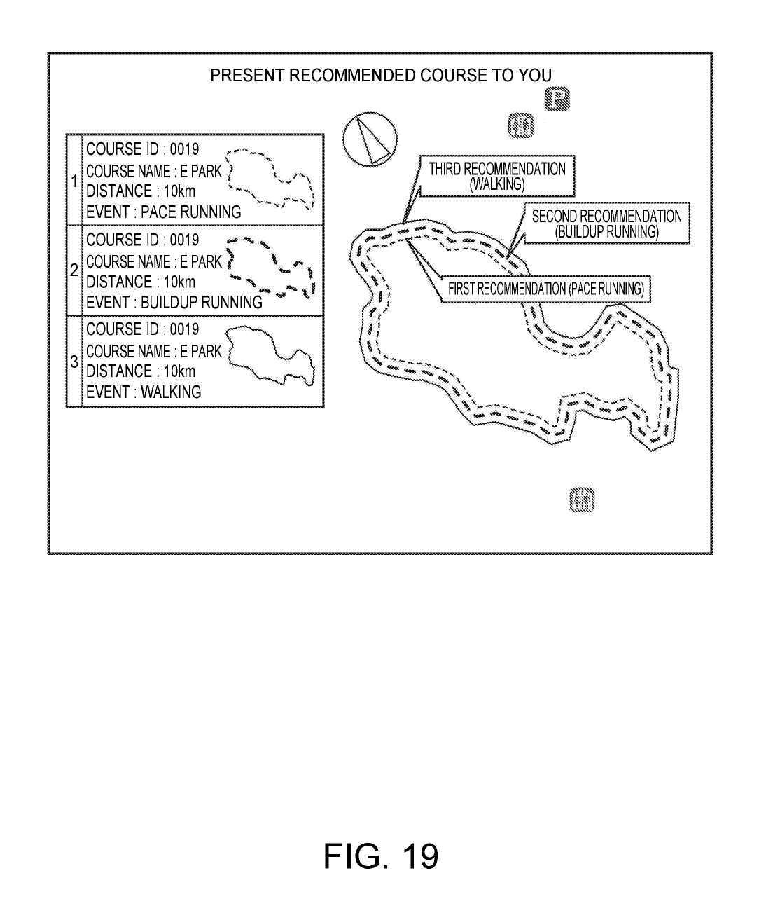

When a plurality of recommended events are given to the same recommended course, that is, when a plurality of recommended courses in which a course is the same and recommended events are different are displayed on the same screen, for example, as shown in FIG. 19, it is desirable that the plurality of recommended courses are superimposed and displayed and the respective plurality of recommended courses are indicated by visual representations corresponding to recommended items given to the recommended courses. In FIG. 19, an example is shown in which curved line images are used as the visual representations of the recommended courses and line types of the curved line images are set to line types corresponding to the recommended events. When the plurality of recommended courses are completely superimposed on the same screen, the plurality of recommended courses cannot be distinguished from one another. Therefore, as shown in FIG. 19, places where the plurality of recommended courses are arranged are desirably properly shifted to a degree for enabling the user to distinguish the plurality of recommended courses from one another.

### 1-22. Display Screen for Recommended Courses (Section Display)

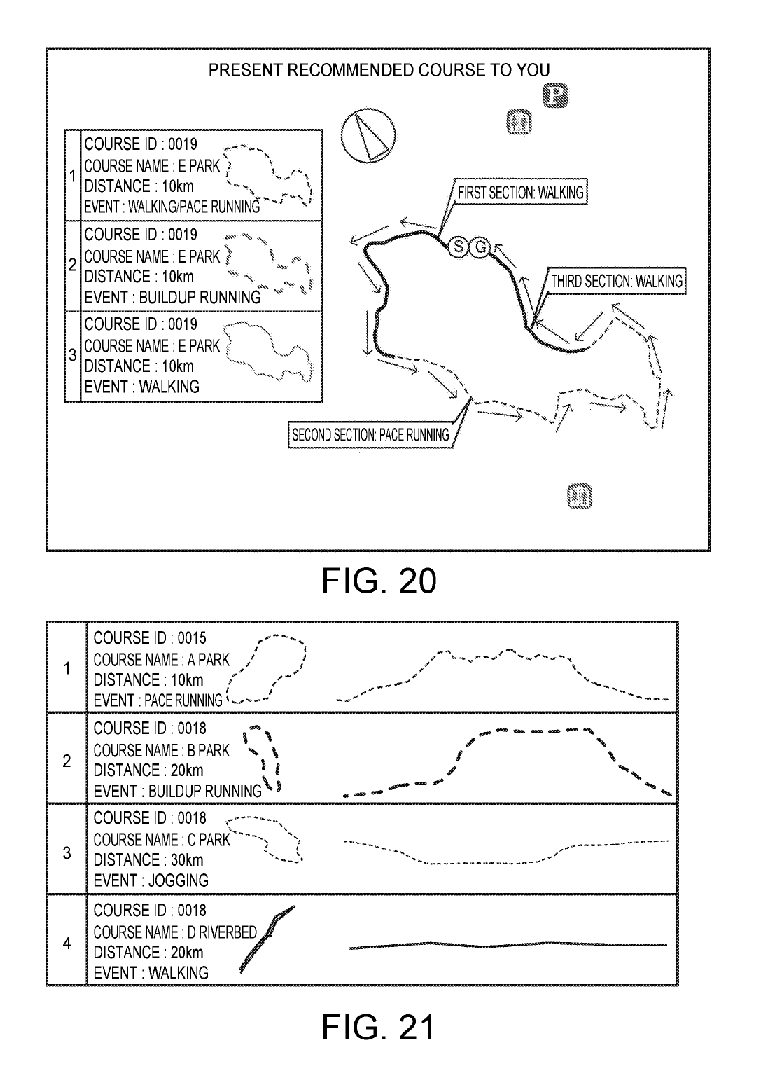

When recommended events are different according to sections in the same recommended course, for example, as shown in FIG. 20, visual representations (line types, line colors, etc.) of the sections of the recommended course are desirably displayed as visual representations corresponding to the recommended events of the sections. In an example shown in FIG. 20, a mark “S” is displayed at a start point of the recommended courses and a mark “G” is displayed at a goal point of the recommended courses. In the following explanation, the start point is referred to as start point S and the goal point is referred to as goal point G.

First, in the example shown in FIG. 20, since a recommended event given to a first section starting from the start point S is the “walking”, the first section is indicated by the visual representation (the solid line image) corresponding to the event “walking”.

In the example shown in FIG. 20, since a recommended event given to a second section starting from the start point S is the “pace running”, the second section is indicated by the visual representation (the broken line image having the standard line width) corresponding to the event “pace running”.

In the example shown in FIG. 20, since a recommended event given to a third section ending at the goal point is the “walking”, the third section is indicated by the visual representation (the solid line image) corresponding to the event “walking”.

Note that a list of the recommended courses are displayed in the order of scores in a predetermined region (a region on the left side when viewed from the user) of the display screen shown in FIG. 20. When the user taps any one of the recommended courses with a finger, only the tapped recommended course changes to a selected state (in FIG. 20, a high contrast state) and the recommended courses not tapped change to an unselected state (in FIG. 20, a gray-out state). Contents of the recommended course in the selected state (the recommended event given to the recommended course, etc.) are displayed on a map in a predetermined region (a region on the right side when viewed from the user) of the display screen. Contents of the recommended courses in the unselected state are hidden on the map. Note that, as shown in FIG. 20, an advancing direction of the courses may be indicated by arrows or the like. Information concerning facilities around the courses such as a parking lot may be displayed on the map as well.

### 1-23. Display Screen for Recommended Courses (an Altitude Map)

For example, as shown in FIG. 21, a recommended course may be displayed as a map (an altitude map) indicating altitudes of points forming the recommended course. That is, the recommended course may be superimposed and displayed on the altitude map. The altitude map may be indicated by a visual representation corresponding to a recommended event given to the recommended course. The altitude map is a map called topographic map or sectional navigation and is a map representing a distribution of altitudes in the recommended course.

In the altitude map shown in FIG. 21, an altitude coordinate axis is arranged in an upward direction when viewed from the user, a position coordinate axis is arranged in a right direction when viewed from the user, and altitudes at respective points of the course are indicated by curved line images. The altitude map of the recommended course is indicated by a line type corresponding to the recommended event given to the recommended course.

On the display screen, a recommended course displayed in a first stage is the “A park” and a recommended event given to the recommended course is the “pace running”. Therefore, the recommended course is indicated by the visual representation (the broken line image having the standard line width) corresponding to the event “pace running”.

On the display screen, a recommended course displayed in a second stage is the “B park” and a recommended event given to the recommended course is the “buildup running”. Therefore, the recommended course is indicated by the visual representation (the broken line image having the line width larger than the standard) corresponding to the event “buildup running”.

On the display screen, a recommended course displayed in a third stage is the “C park” and a recommended event given to the recommended course is the “jogging”. Therefore, the recommended course is indicated by the visual representation (the broken line image having the line width smaller than the standard) corresponding to the event “jogging”.

On the display screen, a recommended course displayed in a fourth stage is the “D riverbed” and a recommended event given to the recommended course is the “walking”. Therefore, the recommended course is indicated by the visual representation (the solid line image) corresponding to the event “walking”.

In the above explanation, the altitude map is represented by the curved line images. However, visual representations other than the simple curved line images, for example, visual representations such as a tube image, a block image, a rope image, a wire image, a ribbon image, an arrow mark, a block image row, and a mark row can also be adopted.

### 1-24. Operation Screen Transition by the User

Screen transition of the display unit 170 of the electronic device 1 is explained.

It is assumed that the server 4 and the electronic device 1 cooperate with each other through a computer program (an application program) executed by the information terminal 2 and a computer program (an application program) executed by the electronic device 1.

The user operates the information terminal 2 before training, captures information concerning a recommended course with a recommended event into the information terminal 2 from the server 4, and transfers the information from the information terminal 2 to the electronic device 1. The user starts the training in a state in which the electronic device 1 is worn on the body and the information terminal 2 is stored or worn in a pocket of clothes, a waist belt, or the like. Therefore, even during the training, the electronic device 1 is capable of capturing information generated by the server 4 through the information terminal 2 as appropriate. The electronic device 1 is also capable of transferring log data acquired during the training to the server 4 through the information terminal 2 as appropriate.

Note that, in this system, a part of the functions of the electronic device 1 may be mounted on the information terminal 2 side. A part or all of the functions of the information terminal 2 may be mounted on the electronic device 1 side. A part or all of the functions of the information terminal 2 may be mounted on the server 4 side. A part or all of the functions of the server 4 may be mounted on the information terminal 2 side. For example, in this system, the processing unit 120 of the electronic device 1 operates as the acquiring unit that acquires physical condition information. However, at least one of the sensors of the electronic device 1 is also capable of operating as the acquiring unit that acquires physical condition information.

For example, when the operation unit 150 is used for input of physical condition information, the operation unit 150 is also capable of operating as the acquiring unit.

For example, when the information terminal 2 has a function of acquiring physical condition information, the operation unit 23 of the information terminal 2 is also capable of operating as the acquiring unit (for example, when the operation unit 23 is used for input of physical condition information).

When the information terminal 2 has the function of acquiring physical condition information, the communication unit 22 of the information terminal 2 is also capable of operating as the acquiring unit.

When the information terminal 2 has the function of acquiring physical condition information, the processing unit 21 of the information terminal 2 is also capable of operating as the acquiring unit.

When the server 4 has the function of acquiring physical condition information, the communication unit 32 of the server 4 is also capable of operating as the acquiring unit.

In this system, at least one of the display unit 170 and the sound output unit 180 of the electronic device 1 may operate as the output unit that presents a recommended route. At least one of the display unit 25 and the sound output unit 26 of the information terminal 2 may operate as the output unit.

Sharing of the functions on the inside of the electronic device 1 (e.g., function sharing between the processing unit functioning as the processor and the display unit that displays a route) is not limited to the function sharing explained above. Sharing of the functions on the inside of the information terminal 2 (e.g., function sharing between the processing unit functioning as the processor and the display unit that displays a route) is not limited to the function sharing explained above.

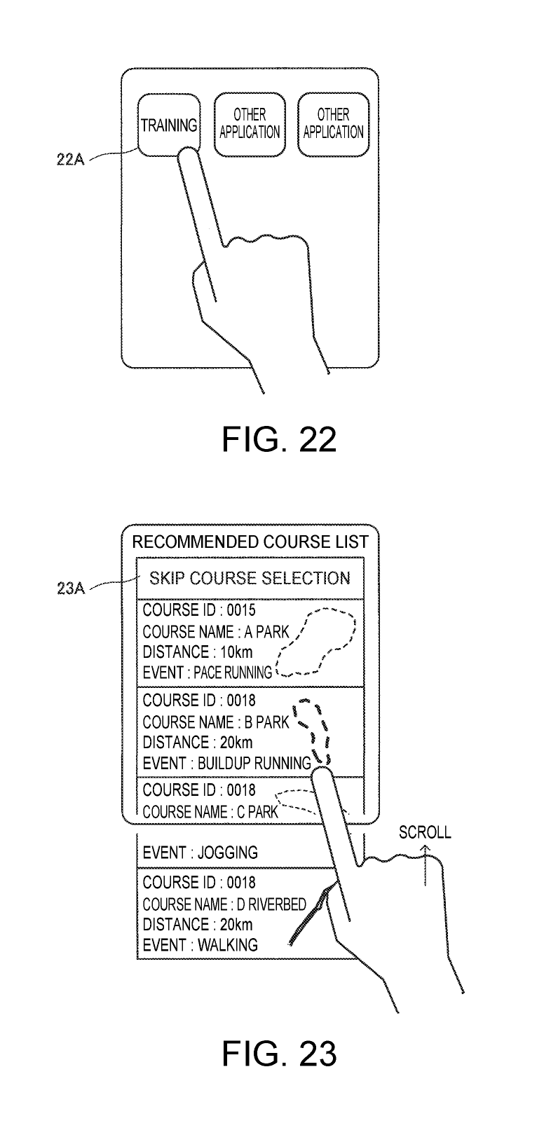

First, before training, for example, as shown in FIG. 22, the user taps, with a finger, an icon 22A “training” displayed on the display screen of the display unit 170 to thereby start an application program of the electronic device 1. The processing unit 120 of the electronic device 1 transmits, according to the application program, data necessary for the course recommendation function among the log data and the like stored by the electronic device 1 and the log data and the like stored by the information terminal 2 to the server 4 in a predetermined format via the information terminal 2. Thereafter, the processing unit 120 of the electronic device 1 receives information such as a recommended course from the server 4 via the information terminal 2 and causes the display unit 170 to display the information such as the recommended course.

Since the size of the display unit 170 of the electronic device 1 is smaller than the size of the display unit 25 of the information terminal 2, the processing unit 120 of the electronic device 1 may display, as a screen for displaying a recommended course and the like, for example, a simple screen shown in FIG. 23 on the display unit 170 instead of the screens shown in FIGS. 17 to 21.

When a plurality of recommended courses are not entirely fit within the display unit 25, the processing unit 120 of the electronic device 1 may scroll the screen according to slide operation by a finger of the user.

When displaying the plurality of recommended courses as a list, the processing unit 120 of the electronic device 1 may dispose a skip button 23A at the top of the recommended courses. For example, when a desired course is absent among the plurality of recommended courses displayed as a list, the user only has to tap the skip button 23A with a finger.

When the skip button 23A is tapped, the processing unit 120 of the electronic device 1 determines that the user has started the training and determines a course and an event in which the user performs the training. Incidentally, even before the training ends, the processing unit 120 of the electronic device 1 is capable of determining a course and an event before a predetermined time elapses after the training is started.

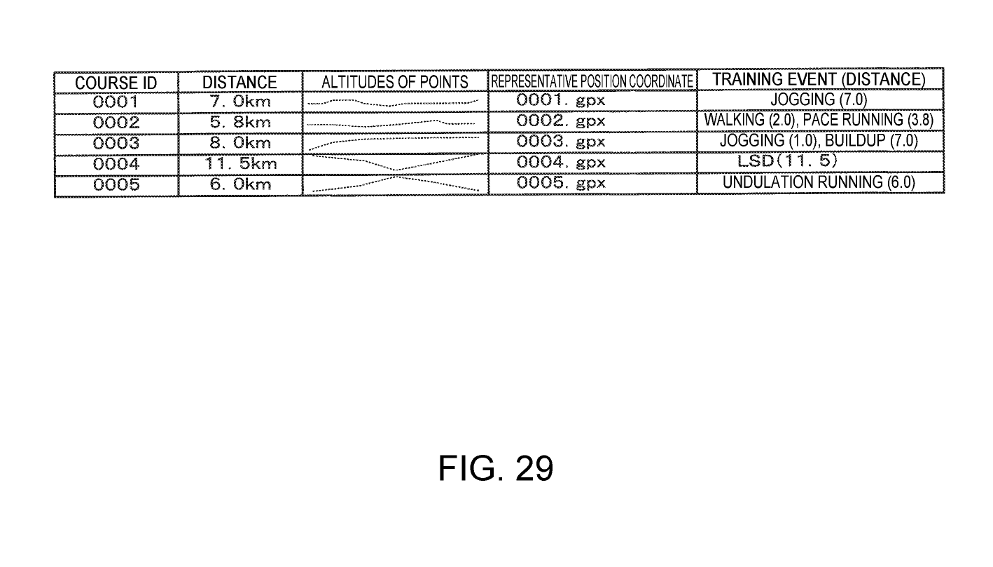

When the processing unit 120 of the electronic device 1 determines a course in which the user is performing the training and the course is same as any one of the plurality of recommended courses, the processing unit 120 develops the navigation function on the basis of course data (FIG. 29) of the recommended course and develops the life logger function and the performance monitor function (however, the life logger function may always develop).

Incidentally, the course data (FIG. 29) of the plurality of recommended courses is transmitted from the server 4 to the electronic device 1 via the information terminal 2 in advance and stored in the storing unit 130 of the electronic device 1. Details of the life logger function and the performance monitor function are as explained above.

On the other hand, when the determined course belongs to none of the plurality of recommended courses, the processing unit 120 of the electronic device 1 develops only the life logger function and the performance monitor function without developing the navigation function (however, the life logger unction may always develop).

The determination of a course by the processing unit 120 of the electronic device 1 can be performed, for example, on the basis of mainly positioning data (latitude, longitude, a speed vector, etc.) output by the GPS sensor 110. The determination of an event (event determination processing) by the processing unit 120 of the electronic device 1 can be performed, for example, on the basis of the positioning data (the speed vector, etc.) output by the GPS sensor 110 and the acceleration data output by the acceleration sensor 113.

Instead of determining a course, the processing unit 120 of the electronic device 1 may cause the user to input a course. Instead of determining a training event, the processing unit 120 may cause the user to input an event.

After the end of the training, when course data of the course in which the user performs the training is new course data, the processing unit 120 of the electronic device 1 uploads the course data to the server 4 via the information terminal 2 together with the log data acquired during the training. Treatment of the log data and the course data in the server 4 is as explained above.

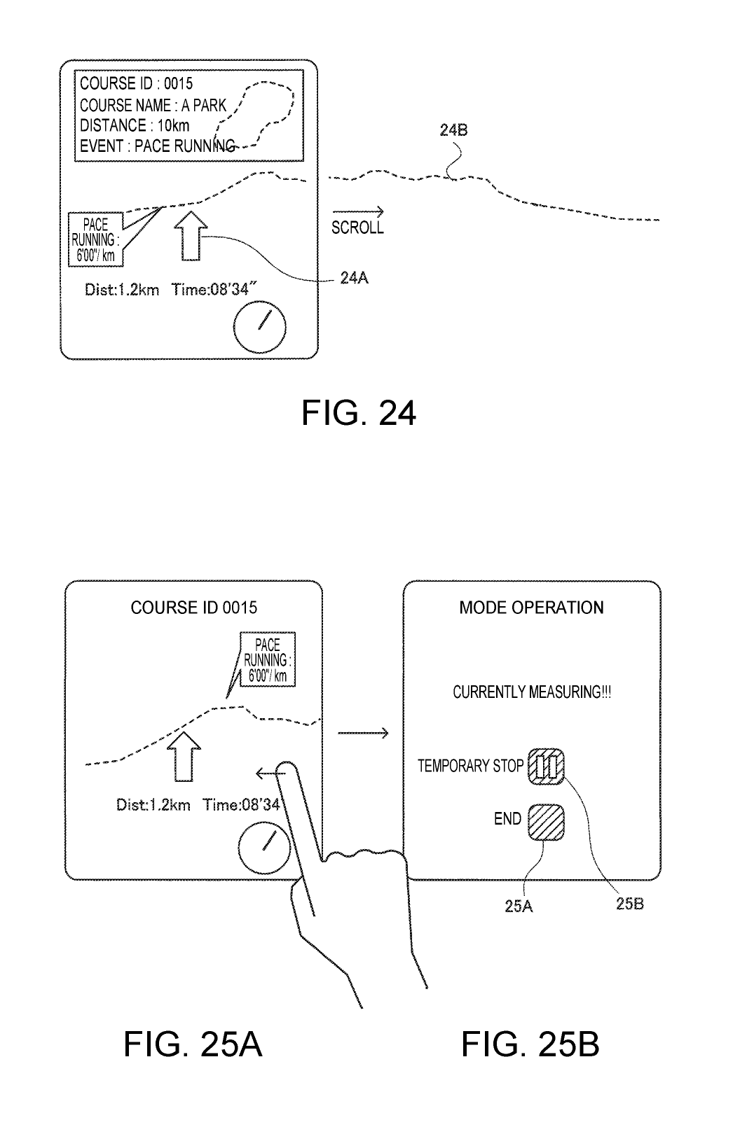

During the training, when the navigation function develops in the electronic device 1, a navigation screen is displayed on the display unit 170. The navigation screen is, for example, as shown in FIG. 24.

### 1-25. Navigation Screen (an Altitude Map)

On the navigation screen shown in FIG. 24, a course in which the user is performing training is displayed as, for example, an altitude map 24B. That is, the display unit 170 superimposes and displays a recommended course on the altitude map 24B.

The altitude map 24B is a map called topographic map or sectional navigation and is a map representing a distribution of altitudes in the course. In the altitude map 24B, a predetermined mark (arrow mark) 24A is given to a part corresponding to the present position of the user. As the user performs the training and a moving distance increases, the position of the mark 24A in the altitude map 24B changes.

In the wearing-type electronic device 1, since the size of the display unit 170 is limited, rather than fitting the entire altitude map 24B in the display unit 170, it is desirable to display, on the display unit 170, only a partial area including a running position of the user in the altitude map 24B and, as the running position of the user changes, scroll the partial area to be displayed. The size of a partial area to be simultaneously displayed in the altitude map 24B is desirably changeable by operation (pinch-in or pinch-out) of the user on the display unit 170.

On the navigation screen, the altitude map 24B of the course is indicated by a visual representation corresponding to a training event performed in the course. In an example shown in FIG. 24, since a training event that the user is performing is pace running, the altitude map 24B is indicated by the visual representation (the broken line image having the standard line width) corresponding to the event “pace running”.

Note that, during the training of the user, the processing unit 120 of the electronic device 1 may sequentially display a part (a cumulative moving distance, a running time, etc.) of the log data on the navigation screen. For example, in a region equivalent to a lower part when viewed from the user on the navigation screen, the cumulative moving distance and the running time are respectively displayed as numerical values together with character images of “Dist”, “Time”, and the like. The numerical values change as the running distance and the running time change.

Thereafter, when the training ends, the user inputs a notification to that effect (an end notification) to the electronic device 1. As the input of the notification, for example, when the user slides the display unit 170 of the electronic device 1 toward a predetermined direction with a finger, an end notification may be input to the electronic device 1. Alternatively, when the user performs a predetermined gesture with an arm on which the electronic device 1 is worn, the end notification may be input to the electronic device 1. The predetermined gesture is, for example, a gesture for swinging the electronic device 1 in a predetermined direction at acceleration equal to or higher than fixed acceleration.

When the end notification of the training is input, the display unit 170 of the electronic device 1 switches a navigation screen (FIG. 25A) to an end screen (FIG. 25B). On the end screen (FIG. 25B), for example, a text image for notifying that measurement is being performed may be disposed. The text image is a text image such as “currently measuring!!!”. That is, whether measuring is being performed may be displayed on the end screen (FIG. 25B).

The user can notify the end of the training to the electronic device 1 and stop the navigation function and the performance monitor function of the electronic device 1 by tapping, with a finger, a stop button 25A disposed on the end screen (FIG. 25B). When the stop button 25A is tapped, the processing unit 120 of the electronic device 1 saves log data acquired from the start of the training to the present point in time by writing the log data in, for example, the storing unit 130. Note that, when the training is temporarily is stopped or ended, the text image such as “currently measuring!!!” on the end screen (FIG. 25B) is hidden or switched to a text image for notifying that the training is temporarily stopped or ended. The text image is, for example, a text image of “temporarily stopped”, “ended”, or the like. That is, whether measuring is being performed may be displayed on the end screen (FIG. 25B).

The user can notify suspension of the training to the electronic device 1 and temporarily stops the navigation function and the performance monitor function of the electronic device 1 by tapping, with a finger, a temporary stop button 25B disposed on the end screen (FIG. 25B). In this state, the user is capable of temporarily leaving the course and taking a rest.

After the rest, when returning to the course, the user can notify resumption of the training to the electronic device 1 and cause the electronic device 1 to resume the navigation function and the performance monitor function by tapping the temporary stop button 25B disposed on the end screen (FIG. 25B) with the finger again. Note that the performance function stops during the temporary stop. However, the life logger function desirably does not stop.

When the suspension of the training is notified from the user, the processing unit 120 of the electronic device 1 suspends the navigation function and the performance monitor function. When the resumption of the training is notified from the user, the processing unit 120 resumes the navigation function and the performance monitor function.

After the resumption of the training is notified from the user, when the end of the training is notified from the user, the processing unit 120 of the electronic device 1 joins log data concerning exercise from the start to the suspension of the training and log data concerning exercise from the resumption to the end of the training. The processing unit 120 saves the joined log data as log data concerning exercise of the entire training.

The processing unit 120 of the electronic device 1 may monitor, on the basis of positioning data output by the GPS sensor 110 after the suspension of the training, a difference between the position of the user before (immediately before) the suspension of the training and the position of the user at the present point in time. When the difference exceeds a threshold, even if the end of the training is not notified, the processing unit 120 may determine that the training ends (i.e., the user forgets to notify the end).

Alternatively, the processing unit 120 of the electronic device 1 may monitor, on the basis of the positioning data output by the GPS sensor 110 after the suspension of the training, the difference between the position of the user before (immediately before) the suspension of the training and the position of the user at the present point in time. When the difference exceeds the threshold, even if the resumption of the training is not notified, the processing unit 120 may determine that the training is resumed (i.e., the user forgets to notify the resumption).

The processing unit 120 of the electronic device 1 may perform the determination on the basis of a difference between moving speeds of the user rather than the difference between the positions of the user.

That is, the processing unit 120 of the electronic device 1 may monitor, on the basis of the positioning data output by the GPS sensor 110 after the suspension of the training, a difference between moving speed of the user before (immediately before) the suspension of the training and moving speed of the user at the present point in time. When the difference exceeds a threshold, even if the end of the training is not notified, the processing unit 120 may determine that the training ends (i.e., the user forgets to notify the end).

Alternatively, the processing unit 120 of the electronic device 1 may monitor, on the basis of the positioning data output by the GPS sensor 110 after the suspension of the training, the difference between the moving speed of the user before (immediately before) the suspension of the training and the moving speed of the user at the present point in time. When the difference exceeds the threshold, even if the resumption of the training is not notified, the processing unit 120 may determine that the training is resumed (i.e., the user forgets to notify the resumption).

Note that, when the training ends after the tap of the skip button 23A, the processing unit 120 of the electronic device 1 may inquire the user about new registration of an event of the training performed by the user and a course in which the user performs the training. For example, the processing unit 120 of the electronic device 1 causes the display unit 170 to display a screen (not shown in the figure) for inquiring about the necessity. When the user inputs a request for the new registration on the screen, the processing unit 120 uploads data of the event and the course of the training to the server 4 in a predetermined format via the information terminal 2.

Note that, in the above explanation, the straight line images having the line types and the line widths different from one another are allocated to the training events different from one another. However, straight line images having line colors different from one another may be allocated to the training events different from one another. Straight line images that flash in patterns different from one another may be allocated to the training events different from one another. Straight line images having textures different from one another may be allocated to the training events different from one another. That is, as the visual representations for distinguishing the training events, the curved line images, at least one of the line colors, the line widths, the line types, the temporal change patterns, and the textures of which are different, can be adopted.

In the above explanation, the altitude map is represented by the curved line images. However, visual representations other than the simple curved line images, for example, visual representations such as a tube image, a block image, a rope image, a wire image, a ribbon image, an arrow mark, a block image row, and a mark row can also be adopted.

On the display screen, times or distances required for the training events may be reflected on the sizes of the visual representations (the curved line images) on the display screen. In this case, the user can intuitively grasp the times or the distances required for the training events from the lengths of the visual representations (the curved line images). Note that an actual time or an actual distance may be reflected on the size of a section in which the user has already moved and a scheduled time or a scheduled distance may be reflected on the size of a section in which the user is about to move.

### 1-26. Navigation Screen (Straight Line Images)

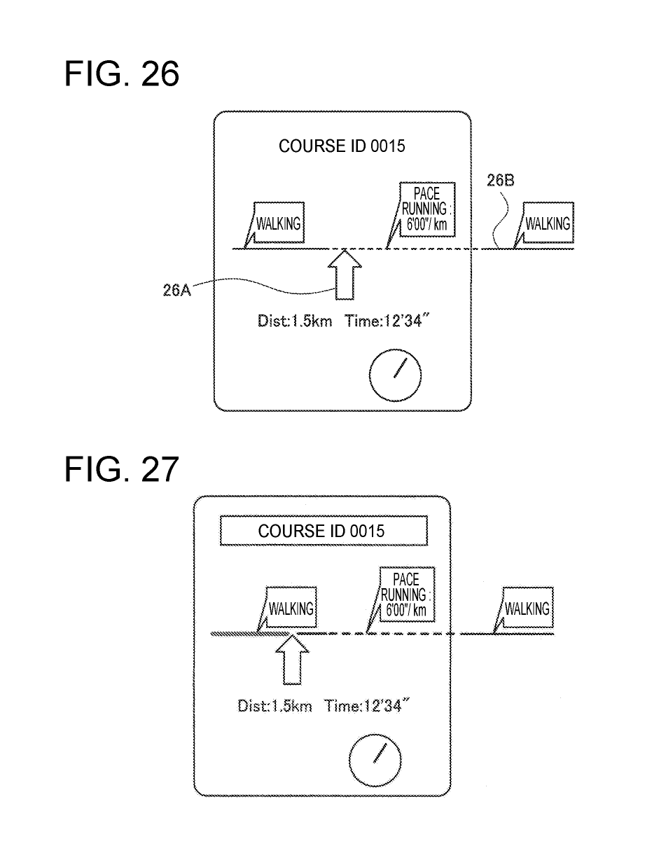

Note that the processing unit 120 of the electronic device 1 can also use, for example, a screen shown in FIG. 26 as a navigation screen besides the screen shown in FIG. 24. Note that, in the screen shown in FIG. 26, explanation is omitted concerning a portion common to the screen shown in FIG. 24.

On the navigation screen shown in FIG. 26, a course in which the user performs training is indicated by a straight line image 26B. A predetermined mark (an arrow mark) 26A is given to a part corresponding to the present position of the user in the straight line image 26B. As the user performs the training and a moving distance increases, the position of the mark 24A in the straight line image 26B changes.

In an example shown in FIG. 26, sections of the course are indicated by visual representations corresponding to training events performed in the sections.

In the example shown in FIG. 26, a training event performed in a first section is walking. Therefore, the first section is indicated by the visual representation (the solid line image) corresponding to the event “walking”.

In the example shown in FIG. 26, a training event performed in a second section is pace running. Therefore, the section is indicated by the visual representation (the broken line image having the standard line width) corresponding to the event “pace running”.

In the example shown in FIG. 26, a training event performed in a third section is walking. Therefore, the third section is indicated by the visual representation (the solid line image) corresponding to the event “walking”.

Note that, when a training event is different for each of sections, in the screen shown in FIG. 24, as in the screen shown in FIG. 26, the training event may be indicated by a different visual representation for each of the sections.

Note that, in the above explanation, the straight line images having the line types and the line widths different from one another are allocated to the training events different from one another. However, straight line images having line colors different from one another may be allocated to the training events different from one another. Straight line images that flash in patterns different from one another may be allocated to the training events different from one another. Straight line images having textures different from one another may be allocated to the training events different from one another. That is, as the visual representations for distinguishing the training events, the curved line images, at least one of the line colors, the line widths, the line types, the temporal change patterns, and the textures of which are different, can be adopted.

In the above explanation, as the visual representations, the straight line images extending in the lateral direction when viewed from the user are adopted. However, visual representations other than the simple straight line images, for example, visual representations such as a tube image, a block image, a rope image, a wire image, a ribbon image, an arrow mark, a block image row, and a mark row can also be adopted.

On the display screen, times or distances required for the training events may be reflected on the sizes of the visual representations (the curved line images) on the display screen. In this case, the user can intuitively grasp the times or the distances required for the training events from the lengths of the visual representations (the curved line images). Note that an actual time or an actual distance may be reflected on the size of a section in which the user has already moved and a scheduled time or a scheduled distance may be reflected on the size of a section in which the user is about to move.

1-27. Gray-Out of a Section in which the User has Already Moved

On the navigation screen shown in FIG. 24, FIG. 26, or the like, a section in which the user has already moved and a section in which the user is about to move in a displayed course may be distinguished. That is, when the user is moving in a recommended route, the display unit 170 (or the processing unit 120) may indicate a section in which the user has moved in the recommended route with a visual representation different from a visual representation of a section in which the user has not moved.

For example, as shown in FIG. 27, the processing section 120 of the electronic device 1 may gray out a section in which the user has already moved in a displayed course to thereby emphasize a section in which the user is about to move. In an example shown in FIG. 27, the present position of the user is indicated by an arrow. In the displayed course, with the arrow as a boundary, the section in which the user has already moved is grayed out and the remaining sections are indicated by line types corresponding to training events.

The gray-out means, for example, means processing for reducing chroma of a part of images displayed on a screen to relatively emphasize impressions of the other images. However, as the processing of the gray-out, for example, at least one of processing for reducing chroma, processing for reducing contrast, and processing for reducing luminance can be used.

### 1-28. Navigation Screen (Map Display)

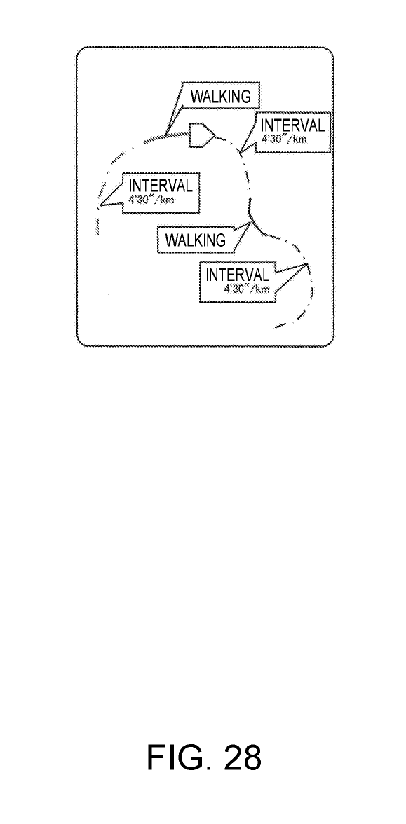

Note that, on the navigation screen (FIG. 24 or 26), the course in which the user performs the training (the recommended course) is indicated by the straight line image or the altitude map. However, for example, as shown in FIG. 28, the recommended course may be superimposed and displayed on a two-dimensional map (note that, in FIG. 28, in order to emphasize the course, display of elements such as landmarks arranged on the map is omitted). The two-dimensional map means a map having a latitude axis and a longitude axis.

Although not shown in the figure, a three-dimensional map can also be used instead of the two-dimensional map. The three-dimensional map is a map having a latitude axis, a longitude axis, and an altitude axis. For example, the three-dimensional map may be a perspective view (a bird-eye view) of a predetermined area viewed from one direction or may be a perspective view (a bird-eye view) in which the visual point is variable. On the navigation screen, two or more maps, for example, a two-dimensional map and an altitude map may be simultaneously displayed side by side.

That is, the display unit 170 may superimpose and display the recommended course on a map. The map may be, for example, at least one of a two-dimensional map including at least a part of the recommended course, a three-dimensional map including at least a part of the recommended course, and a map representing the altitude of at least a part of the recommended route.

Incidentally, in FIG. 28, the recommended course includes a section corresponding to a first training event (interval running), a second section corresponding to a second training event (walking), and a third section corresponding to a third training event (interval running). The first section is indicated by a first visual representation (an alternate long and short dash line image) corresponding to the first training event (interval running). The second section is indicated by a second visual representation (a solid line image) corresponding to the second training event (walking). The third section is indicated by a third visual representation (an alternate long and short dash line image) corresponding to the third training event (interval running).

### 1-29. Details of Course Data

The database 350 stored in the storing unit 34 of the server 4 is explained. FIG. 29 is an example of several course data registered in the database 350.

The database 350 is basically stored in the storing unit 34 of the server 4. However, at least a part of the database 350 is sometimes written in the storing unit 24 of the information terminal 2 via the communication unit 32 of the server 4, the network 3, and the communication unit 27 of the information terminal 2 according to necessity. At least a part of course data written in the storing unit 24 of the information terminal 2 is sometimes written in the storing unit 130 of the electronic device 1 via the communication unit 22 of the information terminal 2 and the communication unit 190 of the electronic device 1 according to necessity.

The database 350 includes course data of various courses. The course data of the respective courses include, for example, course IDs of the courses (identification information of the courses), distances (total lengths) of the courses, altitudes of points forming the courses, position coordinates of points representing the courses, and training events suitably performed in the course. Note that, when there are a plurality of training events suitable for one course, each of the plurality of training events is written in the course data. When a training event is different in each of sections of one course, a distance of the section is written in the course data together with the training event.

For example, the processing unit 31 of the server 4 refers to position coordinates of the courses included in the database 350 and selects, out of the courses, one or a plurality of courses, the distances of which from the present position of the user are within a predetermined distance. Thereafter, the display unit 170 of the electronic device 1 can present, as a recommended course, at least one course present within the predetermined distance from the position of the user before the start of training. That is, the display unit 170 of the electronic device 1 can exclude courses not located near the user from candidates of the recommended course.

For example, the processing unit 31 of the server 4 can determine, on the basis of a psychological fatigue degree and a physical fatigue degree at the present point in time of the user, a training event suitable for the user at the present point in time and select one or a plurality of courses suitable for the training event out of the selected one or a plurality of courses (or exclude one or a plurality of courses not suitable for the training event).

Note that content (data of altitude) of the course data is different between when the user moves in a predetermined direction in a certain course and when the user moves in the opposite direction in the same course. Therefore, two course data may be stored for one course in the database 350. However, when one course data is stored for one course, the processing unit 31 of the server 4 only has to change an array (readout order) of the course data between when a moving direction of the user in the course is a positive direction and when the moving direction is the opposite direction.

The processing unit 31 of the server 4 is also capable of allocating different recommended events in sections different from each other of the recommended course on the basis of a predetermined algorithm (a predetermined selection condition) and the database 350. For example, a course with a course ID 0002 shown in FIG. 29 includes the walking of 2 km and the pace running of 3.8 km. Therefore, when the processing unit 31 of the server 4 selects the course corresponding to the course ID 0002 as the recommended course, the processing unit 31 can generate a recommended course with a recommended event (so-called training menu) by allocating training events to sections of the course to satisfy selection conditions (i) and (ii) described below.

(i) Continuously carry out the pace running as much as possible
(ii) Allocate the walking to a first section and a last section

In this case, the walking is allocated to a first 1 km section of the recommended course corresponding to the course ID 0002, the pace running is allocated to a second 3.8 km section, and the walking is allocated to a last 1 km section.

### 1-30. Flow of the Course Recommendation Processing

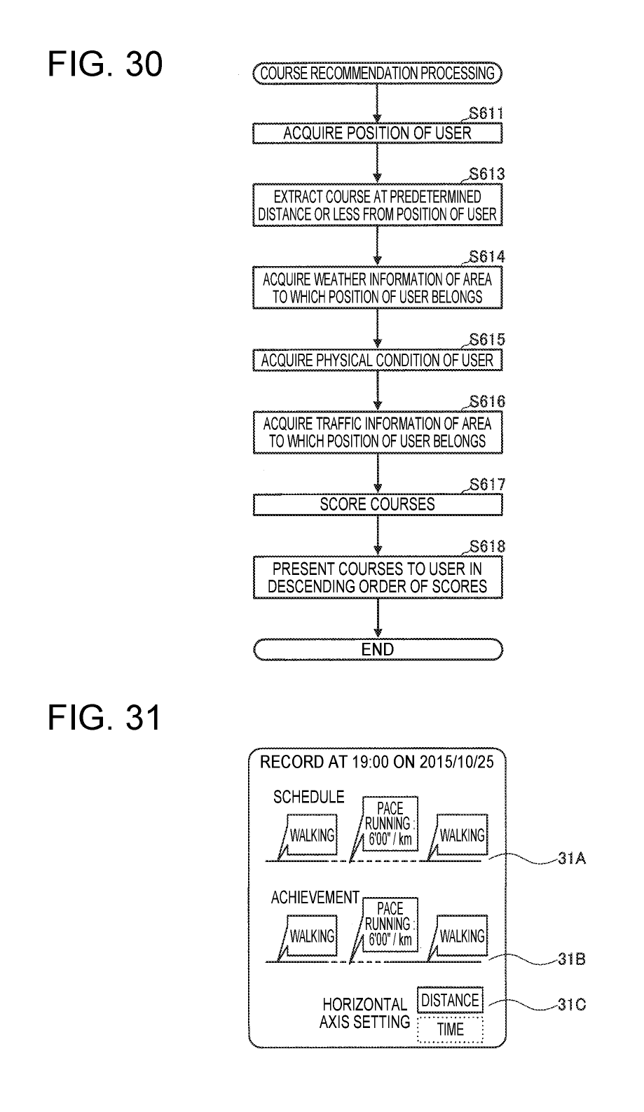

FIG. 30 is a flowchart for explaining an example of the course recommendation processing (an example of an information output method) by the processing unit 31 of the server 4. Note that an algorithm for selecting a recommended course is mainly explained. Prior to the course recommendation processing, log data necessary for grasping physical condition information (a psychological fatigue degree and a physical fatigue degree) of the user is transmitted from the information terminal 2 to the server 4 and added to a log data list 341i corresponding to a user ID=i of the user.

First, the processing unit 31 receives information concerning the present position of the user from the information terminal 2 (S611), searches through the database 350 on the basis of the present position, and extracts one or a plurality of courses (candidates of a recommended course), the distances of which from the present position are equal to or smaller than a threshold (e.g., 20 km or less) (S613). Note that the positions of respective courses registered in the database 350 in advance mean representative positions of the courses. Therefore, a plurality of courses, the distances of which from the representative positions are equal to or smaller than the threshold, are extracted. In the following explanation, it is assumed that the number of extracted recommended courses is two or more. Consequently, a plurality of courses including representative positions in an area to which the present position of the user belongs (a circular area having a radius of 10 km) are extracted.

Subsequently, the processing unit 31 acquires weather information of the area to which the present position of the user belongs from the not-shown weather server via the network 3 (S614). The processing unit 31 transmits information indicating the present position to the not-shown weather server via the communication unit 32 and the network 3 and receives weather information of the area to which the present position belongs from the weather server via the network 3 and the communication unit 32. Note that the area related to the weather information desirably includes the entire plurality of courses extracted in step S613. The weather information may include weather forecast information (a distribution of temperature, a temporal change of temperature, a distribution of precipitation, a temporal change of precipitation, a distribution of air pressure, a temporal change of air pressure, etc.) within a predetermined period including the present point in time and future. Note that use of at least one of the traffic information and the weather information can be omitted.

Subsequently, the processing unit 31 acquires physical condition information (a psychological fatigue degree and a physical fatigue degree) at the present point in time of the user on the basis of the log data list 341i of the user, that is, log data up to the present point acquired concerning the user (S615). Note that processing for acquiring a psychological fatigue degree and a physical fatigue degree is as explained above. The processing unit 31 may cause the user to input a psychological fatigue degree and a physical fatigue degree in a process of the processing (see FIGS. 4 to 7).

Subsequently, the processing unit 31 acquires traffic information of the area to which the present position of the user belongs from the not-shown traffic server via the network 3 (S616). The processing unit 31 transmits the information indicating the present position to the not-shown traffic server via the communication unit 32 and the network 3 and receives traffic information of the area to which the present position belongs from the traffic server via the network 3 and the communication unit 32. Note that the area related to the traffic information desirably includes the entire plurality of courses extracted in step S613. The traffic information may include traffic forecast information (a distribution of congestion degrees, a temporal change of congestion degrees, etc.) within the predetermined period including the present point and future.

Subsequently, the processing unit 31 calculates, on the basis of the present position, the physical condition information, the weather information, and the traffic information, a score of each of the plurality of courses extracted in step S613 (S617). Details of processing for calculating the score are explained below. The score of the course means a degree of recommendation to the user.

Subsequently, the processing unit 31 generates browsing data of the recommended course on the basis of the score of each of the plurality of courses and the course data of the plurality of courses (included in the database 350), transmits the browsing data to the information terminal 2 via the communication unit 32, the network 3, and the communication unit 27, and ends the flow (S618). The browsing data of the recommended course is data in which the plurality of courses are arrayed in the order of scores (see FIGS. 17 to 21, FIG. 23, etc.). Therefore, a plurality of recommended courses are presented to the user in the order of scores. When a display space is limited and not all of the recommended courses can be presented, the processing unit 31 only has to present a predetermined number of recommended courses with high scores in the order of scores. That is, the processing unit 31 may present, as a recommended route, a route with a high degree of recommendation among two or more routes present within a predetermined distance from the position of the user before the start of an activity.

Note that, in the flow explained above, the order of steps can be changed as appropriate.

### 1-31. Score Calculation Processing

Processing for calculating a score of a course is explained below.

A score of a course is calculated by, for example, Expression (1) described below.

score=k₁×h+p(d|k₂)−k₃×N_{S} (1)

Meanings of parameters in Expression (1) are as described below.

h: The absolute value of an elevation difference of the course and is, for example, the absolute value of larger one of a cumulative ascending altitude and a cumulative descending altitude in the course.
d: The distance, that is, the total length of the course. A distance d of the course is registered in the database 350 in advance.
N_{S}: The number of points where the user should stop in the course and is, for example, the number of signals disposed in the course.
k₂: An ideal distance derived from physical condition information and weather information. For example, the parameter k₂ is set longer as a physical condition of the user is better (a fatigue degree is lower) and is set shorter as the temperature of the course is higher. Note that the physical condition used for the calculation of the parameter k₂ is, for example, a physical fatigue degree, in particular, a fatigue degree (a normal time heart rate or the like) in the daytime in a recent predetermined period of the user. For example, as the parameter k₂, for example, in the same physical condition, the ideal distance is set to 10 km if the temperature is 20° C. and set to 8 km if the temperature is 25° C.
p(d|k₂): A value indicating a coincidence degree of the parameter k₂ and the actual distance d of the course and is, for example, a value p(k₂) obtained by substituting the actual distance d in a normal distribution p(k₂) centering on the parameter k₂.
k₁: An indicator indicating a physical fatigue degree of the user. For example, the user can derive the parameter k₁ from, for example, a required time of stair ascending and descending performed by the user in the recent predetermined period. A score of a course with a large elevation difference is higher as the required time of the stair ascending and descending is shorter.
k₃: An indicator set according to weather information. For example, the parameter k₃ is set to “2” when precipitation is large (when it rains) and set to “1” when precipitation is small (when it is fine). A score of a course with a small number of times of stop is higher as the parameter k₃ is larger.

Note that values of the parameters k₁, k₂, and k₃ in Expression (1) also play a role of normalization for adjusting weights of the terms in Expression (1). Therefore, the processing unit 31 may adjust a magnitude relation among the parameters k₁, k₂, and k₃ according to, for example, an instruction from the user.

### 1-32. Other Score Calculation Processing

Note that, besides calculating a score on the basis of a physical condition of the user, the processing unit 31 may calculate a score on the basis of a recommended training event to the user or a training event selected by the user (hereinafter collectively referred to as “training event”).

For example, the processing unit 31 may set a score of the course higher as a coincidence degree of inclination suitable for the training event and inclination of the course is higher. Note that a value of optimum inclination is stored in the storing unit 34 of the processing unit 31 in advance for each training event. The processing unit 31 refers to the value of the inclination as appropriate.

The processing unit 31 may set the score of the course higher as a coincidence degree a distance suitable for the training event and the distance of the course is higher. Note that a value of an optimum distance is stored in the storing unit 34 of the processing unit 31 in advance for each training event. The processing unit 31 refers to the value of the distance as appropriate.

The processing unit 31 may set the score of the course higher as a coincidence degree of speed suitable for the training event and general moving speed in the course is higher. Note that a value of optimum speed is stored in the storing unit 34 of the processing unit 31 in advance for each training event. The processing unit 31 refers to the value of the speed as appropriate. In the database 350, a value of general moving speed is stored in advance for each training event. The processing unit 31 refers to the value of the speed as appropriate.

The processing unit 31 may set the score of the course higher as a coincidence degree of an elevation difference suitable for the training event and the elevation difference of the course is higher. Note that a value of an optimum elevation difference is stored in the storing unit 34 of the processing unit 31 in advance for each training event. The processing unit 31 refers to the value of the elevation difference as appropriate.

If the processing unit 31 determines the score in this way, when the user performs training in the recommended course, it is possible to reduce a risk of injury of the user, improve a training effect, and effectively perform recovery from fatigue of the user.

### 1-38. Other Event Recommendation Processing

Note that the processing unit 31 of the server 4 executes, before the start of the training, the processing for determining a recommended event and a recommended course. However, the processing unit 31 may execute the processing before the start of the training and thereafter execute the processing again during the training. This is because, for example, it is also likely that a bad physical condition of the user in the beginning of the training changes for the better during the training and the recommended event and the recommended course change.

However, in that case, necessary log data is sequentially uploaded to the server 4 during the training via the communication unit 190 of the electronic device 1, the communication unit 22 of the information terminal 2, the communication unit 27, the network 3, and the communication unit 32.

Note that, when the processing unit 31 of the server 4 notifies the user of a recommended event with a load higher than a load of an initial recommended event, the processing unit 31 may change a training menu, for example, increase the number of turns in the course, instead of changing the recommended course.

The processing unit 120 of the electronic device 1 or the processing unit 21 of the information terminal 2 may determine a recommended event or a recommended course during the training instead of the processing unit 31 of the server 4.

### 1-34. Feedback Screen

After the end of the training, the processing unit 120 of the electronic device 1 switches the display screen of the display unit 170 from the navigation screen explained above to a feedback screen. The feedback screen means a screen for the user to compare a training schedule indicating a schedule of training and a training achievement indicating an achievement of the training.

FIG. 31 is an example of the feedback screen. In the screen shown in FIG. 31, a training schedule 31A, a training achievement 31B, and a button 31C for horizontal axis setting are displayed side by side.

In FIG. 31, in the training schedule 31A, a recommended course presented to the user before the start of training is indicated by a visual representation (a broken line image having a standard line width) corresponding to a recommended event “pace running”.

Note that, in the example shown in FIG. 31, a recommended event in a first section of the recommended course is walking (a solid line image), a recommended event in a second section is pace running (a broken line image having a standard line width), and a recommended event in a third section is the walking (the solid line image).

In the training achievement 31B, a course in which the user actually moves from the start to the end of the training is indicated by the visual representation (the broken line image having the standard line width) corresponding to the actually performed training event “pace running”.

Note that, in the example shown in FIG. 31, the walking (the solid line image) is performed in the first section of the course, the pace running (the broken line image having the standard line width) is performed in the second section of the course, and the walking (the solid line image) is performed in the third section of the course.

That is, the display unit 170 displays at least one course in which training is performed. The processing unit 120 performs control for indicating at least apart of at least one course with a visual representation corresponding to an event of training performed in the part. Note that the at least one course may include a first section corresponding to first training and a second section corresponding to second training. The first section may be indicated by a first visual representation corresponding to a type of the first training. The second section may be indicated by a second visual representation corresponding to a type of the second training.

In the example shown in FIG. 31, the button 31C for horizontal axis setting is set to “distance”. Therefore, in the training schedule 31A and the training achievement 31B, the lengths of the sections are set to lengths corresponding to distances of the sections.

Therefore, the user can compare content of training actually performed by the user and content of training recommended to the user on the same screen in detail.

Note that, when the button 31C for horizontal axis setting is switched from “distance” to “time”, in the training schedule 31A and the training achievement 31B, the lengths of the sections are switched to lengths corresponding to times of the sections.

The processing unit 120 of the electronic device 1 can generate, on the basis of log data acquired during the training, information concerning the training achievement 31B that should be displayed on the feedback screen.

In the above explanation, the display unit 170 of the electronic device 1 displays the feedback screen. However, the display unit 25 of the information terminal 2 may display the feedback screen. The processing unit 120 of the electronic device 1 may generate the feedback screen. The processing unit 31 of the server 4 may generate the feedback screen. Note that, when the processing unit 21 of the information terminal 2 generates the feedback screen, the log data acquired during the training needs to be transferred to the information terminal 2 via the communication unit 190 of the electronic device 1 and the communication unit 22 of the information terminal 2. When the processing unit 31 of the server 4 generates the feedback screen, the log data acquired during the training needs to be transferred to the information terminal 2 via the communication unit 190 of the electronic device 1, the communication unit 22 of the information terminal 2, the communication unit 27 of the information terminal 2, the network 3, and the communication unit 32 of the server 4.

Note that the at least one course displayed on the feedback screen may include the first course corresponding to the first training and the second course corresponding to the second training different from the first course. The first course may be indicated by the first visual representation corresponding to the event of the first training. The second course may be indicated by the second visual representation corresponding to the event of the second training. A display method in displaying a plurality of courses on the feedback screen is the same as the display method in displaying the plurality of recommended courses. The plurality of courses may be displayed by a method of, for example, displaying the plurality of courses side by side, displaying a selected course, or sequentially displaying the plurality of courses.

### 1-35. Flow of Event Determination Processing (Overall)

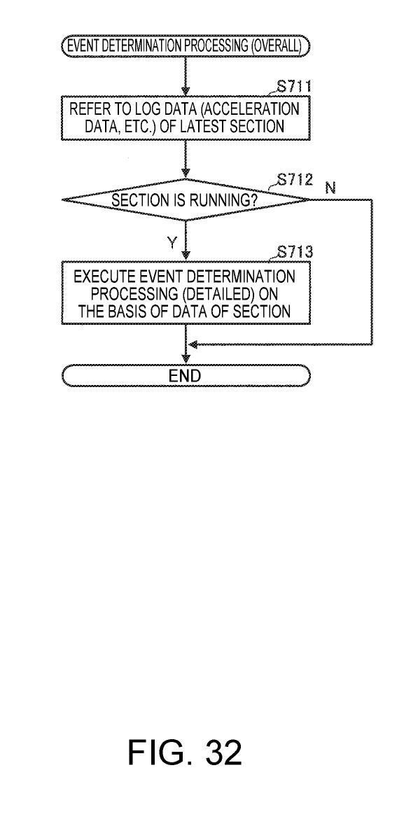

FIG. 32 is a flowchart of event determination processing (overall) for training.

It is assumed that an entity of the event determination processing (overall) is the processing unit 120 of the electronic device 1 and timing when the event determination processing (overall) is executed is timing during training. However, the entity of the event determination processing (overall) may be the processing unit 21 of the information terminal 2 or the processing unit 31 of the server 4. The timing when the event determination processing (overall) is executed may be timing after the training. However, when the entity is the processing unit 21 or the processing unit 31, log data during the training is transferred to the information terminal 2 or the server 4 during the training or after the training via the communication unit 190 of the electronic device 1, the communication units 22 and 27 of the information terminal 2, the network 3, the communication unit 32 of the server 4, and the like.

The flow shown in FIG. 32 is repeatedly executed by the processing unit 120 of the electronic device 1 at a predetermined cycle (a five-second cycle) after the start of the training.

First, the processing unit 120 of the electronic device 1 refers to log data in the latest section (the latest section for five seconds) (S711). “Section” in the explanation of the flow means a section formed by performing time division of a training period and is different from a section (a section formed by performing distance division) in other explanation. The log data referred to is log data indicating an exercise state of the user and the position of the user and is, for example, acceleration data output by the acceleration sensor 113, positioning data output by the GPS sensor 110, and air pressure data output by the air pressure sensor 112. A sampling cycle of the log data is a cycle (e.g., one second or less) shorter than an execution cycle (five seconds) of the flow.

Subsequently, the processing unit 120 of the electronic device 1 determines, on the basis of the log data referred to, whether a type of an action of the user in the present section is “running” (S712). The determination is determination for determining whether the type of the action is “running” or is “walking” or “stop”.

For example, the processing unit 120 analyzes main components of acceleration data in the section. The processing unit 120 determines that the type of the action is the “running” when the magnitude of a first characteristic value is equal to or larger than fixed magnitude and a peak frequency (a peak frequency of a Fourier spectrum) of FFT of a first main component is near 1.5 Hz or 3.0 Hz. The processing unit 120 determines that the type of the action is the “walking” when the magnitude of the first characteristic value is equal to or larger than the fixed magnitude and the peak frequency (the peak frequency of the Fourier spectrum) of FFT of the first main component is near 1.0 Hz or 2.0 Hz. Otherwise, the processing unit 120 determines that the type of the action is the “stop”.

When the type of the action is the “walking” or the “stop” (N in S712), the processing unit 120 skips the next step S713 and ends the flow. When the type of the action is the “running” (Y in S712), the processing unit 120 executes the next step S713.

Subsequently, the processing unit 120 of the electronic device 1 executes event determination processing (detailed) concerning the present section to thereby determine a training event in the present section and ends the flow (S713). The processing unit 120 determines, on the basis of log data (e.g., apace and a heart rate) of the present section, an event of training performed in the present section. A flow of the event determination processing (detailed) is as explained below.

### 1-36. Flow of the Event Determination Processing (Detailed)

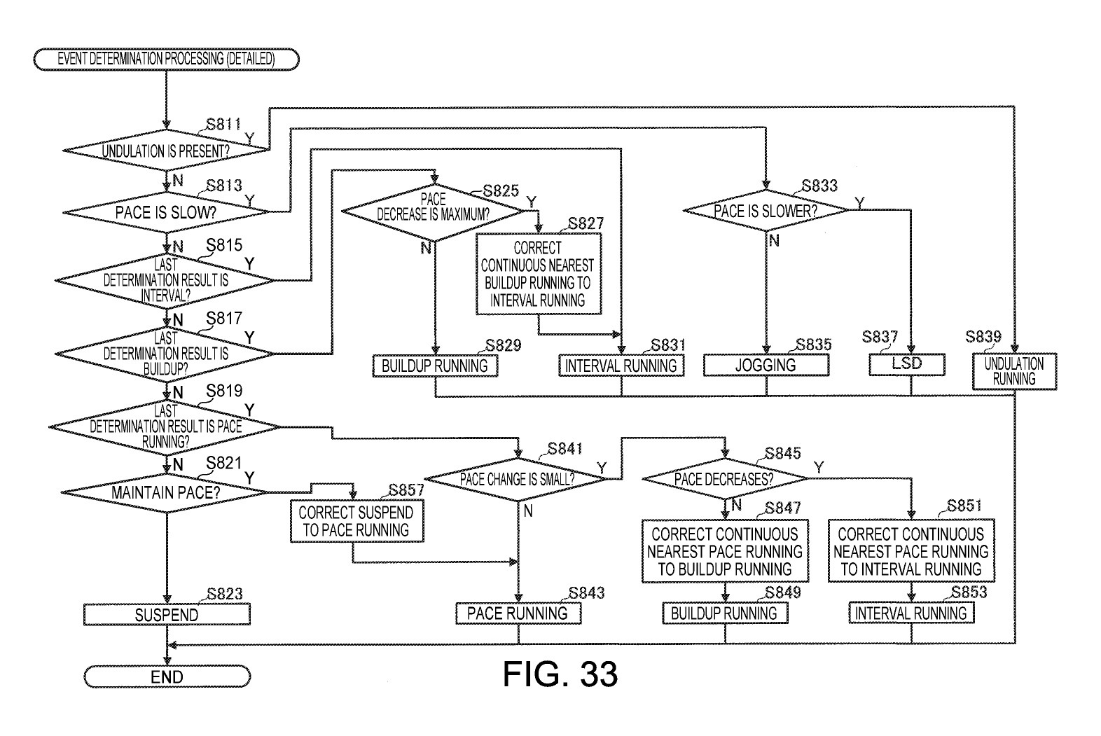

FIG. 33 is a flowchart of event determination processing (detailed) for training.

It is assumed that an entity of the event determination processing (detailed) is the processing unit 120 of the electronic device 1 and timing when the event determination processing (detailed) is execute is timing during the training. However, the entity of the event determination processing (detailed) may be the processing unit 21 of the information terminal 2 or the processing unit 31 of the server 4. The timing when the event determination processing (detailed) is executed may be timing after the training. However, when the entity is the processing unit 21 or the processing unit 31, log data (which only has to include at least log data explained below) during the training is transferred to the information terminal 2 or the server 4 during the training or after the training via the communication unit 190 of the electronic device 1, the communication units 22 and 27 of the information terminal 2, the network 3, the communication unit 32 of the server 4, and the like.

The flow shown in FIG. 33 is repeatedly executed by the processing unit 120 of the electronic device 1 at a predetermined cycle (a five-second cycle) during the training.

In the flow shown in FIG. 33, the processing unit 120 determines to which of five events “buildup running”, “interval running”, “jogging”, “LSD”, and “undulation running” training performed in the latest five-second section belong (steps S829, S831, S835, S837, and S839). However, among the five events, the determination of the three events the “buildup running”, the “interval running”, and the “LSD” cannot be immediately decided only with the log data of one section. Therefore, results of determination in a plurality of sections are comprehensively taken into account. Therefore, processing for suspending a determination result of the latest section (S823) and processing for correcting a determination result concerning preceding sections (S841 to S857) are inserted into the flow shown in FIG. 33. The steps are explained below.

First, the processing unit 120 determines on the basis of data of a position and an altitude included in log data of the present section whether undulation equal to or larger than appropriate inclination is present in the present section (S811). When the undulation is present (Y in S811), the processing unit 120 determines a training event performed in the present section as the “undulation running” (S839) and ends the flow. Otherwise (N in S811), the processing unit 120 shifts to the next determination processing.

The processing unit 120 determines on the basis of data of a pace included in the log data of the present section whether a pace in the present section is slower than a first threshold (e.g., 7′00″/km) (S813). When the pace in the present section is slower than the first threshold (Y in S813), the processing unit 120 shifts to processing for distinguishing the “jogging” and the “LSD” (S833 to S837). Otherwise (N in S813), the processing unit 120 shifts to determination processing (S815) based on a determination result in a preceding section.

Subsequently, the processing unit 120 determines whether the last determination result is the “interval running” (S815). However, since the last determination result is absent in the first step S815, the processing unit 120 immediately shifts to the next determination processing. When the last determination result is the “interval running” (Y in S815), the processing unit 120 determines a determination result in the present section as the “interval running” (S831) and ends the flow. Otherwise (N in S815), the processing unit 120 shifts to the next determination processing (S817).

Subsequently, the processing unit 120 determines whether the last determination result is the “buildup running” (S817). However, since the last determination result is absent in the first step S817, the processing unit 120 immediately shifts to the next determination processing. When the last determination result is the “buildup running” (Y in S817), the processing unit 120 shifts to processing for distinguishing the “buildup running” and the “interval running” (S825 to S831). Otherwise (N in S817), the processing unit 120 shifts to the next determination processing (S819).

Subsequently, the processing unit 120 determines whether the last determination result is the “pace running” (S819). However, since the last determination result is absent in the first step S819, the processing unit 120 immediately shifts to the next determination processing. When the last determination result is the “pace running” (Y in S819), the processing unit 120 shifts to processing concerning correction (S841 to S853). Otherwise (N in S819), the processing unit 120 shifts to the next determination processing (S821).

Subsequently, the processing unit 120 determines on the basis of log data included in the latest predetermined period T1 (e.g., two or more sections) whether a pace is maintained in the predetermined period T1 (S821). When determining that the pace is maintained (Y in S821), the processing unit 120 corrects the last determination result “suspend” in the sections up to the last time to the “pace running” (S857) and then determines the determination result in the present section as the “pace running” (S843) and ends the flow. On the other hand, when the pace is not maintained (N in S821), the processing unit 120 determines the determination result in the present section as the “suspend” (S823) and then ends the flow.

Subsequently, processing for distinguishing the “buildup running” and the “interval running” (S825 to S831) is explained.

First, the processing unit 120 determines whether a pace decrease amount in the present section based on an average pace in the sections up to the last time is equal to or larger than a threshold (60 seconds/km) (S825). When the pace decrease amount is not equal to or larger than the threshold (N S825), the processing unit 120 determines a determination result in the present section as the “buildup running” (S829) and ends the flow. When the pace decrease amount is equal to or larger than the threshold (Y in S825), the processing unit 120 corrects the “buildup running” in the section continuing to the present section to the “interval running” (S827), determines the determination result in the present section as the “interval running” (S831), and ends the flow.

Processing for distinguishing the “jogging” and the “LSD” (S833 to S837) is explained.

First, the processing unit 120 determines whether apace in the present section is slower than a second threshold (e.g., 7′00″/km) slower than the first threshold (S833). When the pace of the present section is not slower than the second threshold (N in S833), the processing unit 120 determines the determination result in the present section as the “jogging”. Otherwise (Y in S833), the processing unit 120 determines the determination result in the present section as the “LSD” (S837) and then ends the flow.

Processing for correcting a determination result concerning a preceding section (S841 to S857) is explained.

First, the processing unit 120 determines whether the magnitude of a difference (a pace change amount) between an average pace in the continuous section up to the last time in which the determination result is the pace running and a pace in the present section is equal to or larger than a threshold (30 seconds/km) (S841). When the magnitude of the pace change amount is not equal to or larger than the threshold (N in S841), the processing unit 120 determines the determination result in the present section as the “pace running” (S843) and then ends the flow.

On the other hand, when the magnitude of the pace change amount is equal to or larger than the threshold (Y in S841), the processing unit 120 shifts to further determination processing (S845).

In the further determination processing (S845), the processing unit 120 determines whether the pace in the present section is slower than the average pace in the continuous section up to the last time in which the determination result is the pace running (S845).

When determining that pace in the present section is not slower than the average pace (N in S845), the processing unit 120 corrects the determination result “pace running” in the continuous section to the “buildup running” (S847), determines the determination result in the present section as the “buildup running” (S849), and ends the flow.

When determining that the pace in the present section is slower than the average pace (Y in S845), the processing unit 120 corrects the determination result “pace running” in the continuous section to the “interval running” (S851), determines the determination result in the present section as the “interval running” (S853), and ends the flow.

Note that, as a result of repeating the flow explained above during the trailing, training events performed by the user in the sections (determination results) are decided. Information concerning the event (the determination result) of each of the sections is incorporated in, for example, log data of the training and transferred to the server 4 in a predetermined format via the communication unit 190 of the electronic device 1, the communication unit 22 of the information terminal 2, the communication unit 27, the network 3, and the communication unit 32 of the server 4. The log data is registered in the database 350 of the storing unit 34 of the server 4. A format of course data is as explained above.

### 1-37. Feedback Screen (a Pie Graph)

After the end of the training, the processing unit 120 of the electronic device 1 switches the display screen of the display unit 170 from the navigation screen to the feedback screen. The feedback screen means a screen showing an achievement of the training.

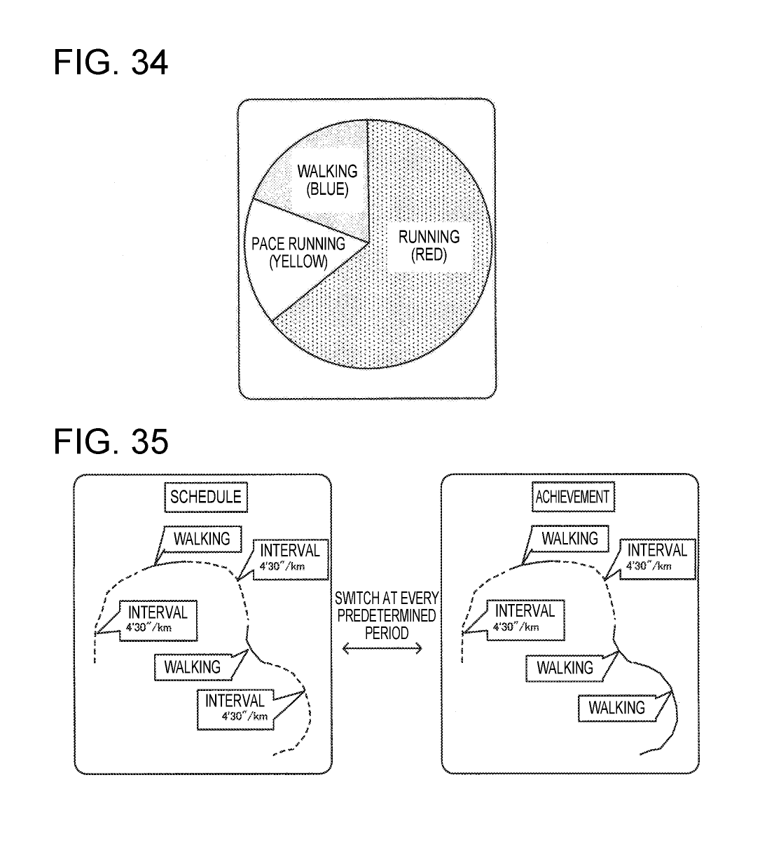

FIG. 34 is an example of a training achievement (a graph by events). On a screen shown in FIG. 34, ratios of events performed in one time of training are represented by a pie graph. Center angles of regions of the pie graph represent the lengths of training times (or distances). In the example shown in FIG. 34, a pie graph of the running, the pace running, and the walking performed in the one time of training is shown.

In the pie graph, a fan-shaped region corresponding to the running is indicated by a visual representation (e.g., a red hatching pattern) corresponding to the running. A fan-shaped region corresponding to the pace running is indicated by a visual representation (e.g., a yellow hatching pattern) corresponding to the pace running. A fan-shaped region corresponding to the walking is indicated by a visual representation (e.g., a blue hatching pattern) corresponding to the walking. The visual representations only have to be representations distinguishable from one another. For example, colors, hatching patterns, figures, and the like and combinations of the colors, the hatching patterns, the figures, and the like can be used.

In the above explanation, the achievement concerning the one time of training is displayed on the feedback screen. However, an achievement concerning a plurality of times of training may be displayed. For example, an achievement concerning training in recent one month may be displayed.

### 1-38. Feedback Screen (Map Display)

As shown in FIG. 35, the map display (see FIG. 28) can be adopted for the feedback screen as well. That is, the display unit 170 may superimpose and display, on a map, at least one course in which the user performs training. The map display is a display method for superimposing and displaying a course on a two-dimensional map (a map having a latitude axis and a longitude axis). In this case, sections of the course are indicated by visual representations corresponding to events performed in the sections (or visual representations corresponding to recommended events in the sections). Note that the map may be at least one of a two-dimensional map including at least a part of the course, a three-dimensional map including at least a part of the course, and a map representing the altitude of at least apart of the course (note that, in FIG. 35, in order to emphasize the course, display of elements such as landmarks arranged on the map is omitted).

When displaying the feedback screen as a map, the processing unit 120 may simultaneously display a training schedule and a training achievement side by side. As shown in FIG. 35, the processing unit 120 may switch the display screen between a screen on which the training schedule is displayed (equivalent to the navigation screen) and a screen on which the training achievement is displayed. In this case, the processing unit 120 may set timing for performing the switching of the display screen to each predetermined time (e.g., each one second) or timing when the user performs any action. When the size of the display screen is limited like the display unit 170 of the electronic device 1, the switching of the display screen is particularly effective.

### 1-39. Feedback Screen (Altitude Map)

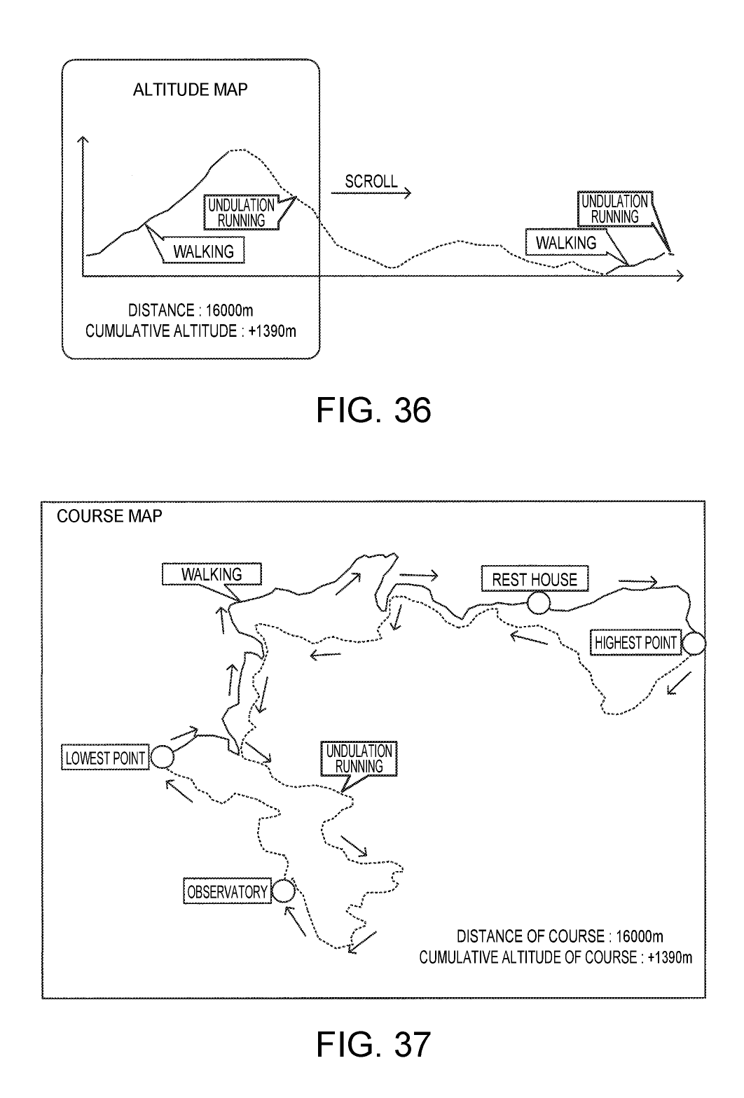

As shown in FIG. 36, the altitude map (see FIG. 24) can also be adopted for the feedback screen. The altitude map is a curved line image of a graph in which an altitude coordinate axis is arranged in the up-down direction when viewed from the user and a position coordinate axis is arranged in the left-right direction when viewed from the user.

Sections of a course shown in FIG. 36 are indicated by visual representations corresponding to training events performed in the sections. In an example shown in FIG. 36, most of sections formed by uphill roads are indicated by a visual representation (a solid line image) corresponding to the “walking”. Most of sections formed by downhill roads are indicated by visual a visual representation (a dotted line image) corresponding to the “undulation running”.

With such a feedback screen, the user is capable of verifying (reviewing), after training, whether allocation of walking and running in the training is appropriate compared with allocation of gradients of the course. For example, the user can grasp a correlation between gradients and speeds in the sections of the course such as apace decrease in the uphill roads and a pace increase in the downhill roads.

For example, when the user moves in a marathon course, the processing unit 120 can acquire a tabulation result (a numerical value such as “a finish rate of 80%”) indicating whether the user was able to run all sections of the course or whether the user did not walk in all the sections and can display the tabulation result to the user together with the feedback screen. The display of the tabulation result can be adopted for various feedback screens.

### 1-40. Loop-Like Course

When a course is loop-like, if a course is superimposed on a map, it is difficult to distinguish courses of second and subsequent laps from the preceding courses.

Therefore, the processing unit 120 of the electronic device 1 may shift and display the courses of the second and subsequent laps to the inner side of the preceding course or may switch and display courses in laps different from one another at every predetermined time (every one second). These methods are particularly effective in training on a track.

For example, as shown in FIG. 37, the processing unit 120 may display an advancing direction of the user in the course on a map (with an arrow mark or the like). In an example shown in FIG. 37, the processing unit 120 causes the display unit 25 of the information terminal 2 to display the map instead of the display unit 170 of the electronic device 1. Since limitation on the size of the display unit 25 of the information terminal 2 is less than the limitation of the size of the display unit 25 of the information terminal 2, it is possible to display a more complicated course (a more detailed course shape).

### 1-41. Type Diagnosis

The processing unit 31 of the server 4 may diagnose a type of the user on the basis of log data (including log data acquired in the latest training) of the user stored in the storing unit 34 or may use the diagnosed type for determination of a recommended course or determination of a recommended event executed in the next and subsequent times. Note that the type of the user means a tendency of a physical ability or a tendency of training and is, for example, distinction of a “stamina type” and a “speed type”.

For example, when the user inputs the type (distinction of the “stamina type”, the “speed type”, and the like) of the user via the operation unit 23 of the information terminal 2, the processing unit 31 of the server 4 may receive the type from the information terminal 2 and determine a recommended course or a recommended event matching the type.

### 1-42. Off-Course Determination

The processing unit 120 of the electronic device 1 may execute off-course determination processing during the display of the navigation screen and, when a course in which the user is actually moving deviates from a recommended course, notify the user to that effect. The off-course determination processing is explained below.

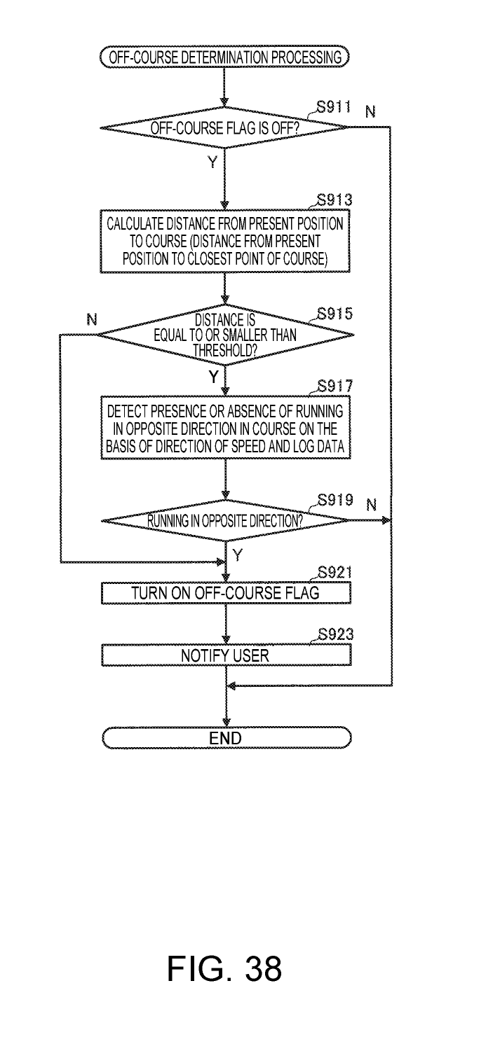

FIG. 38 is a flowchart for explaining an example of the off-course determination processing. The storing unit 24 of the electronic device 1 has stored therein an off-course flag. The off-course flag is turned on and off by the processing unit 120 according to necessity. The off-course flag is off in the beginning of training. A flow explained below is repeatedly executed during the training.

First, the processing unit 120 refers to the off-course flag and determines whether the off-course flag is off (S911). When the off-course flag is off (Y in S911), the processing unit 120 shifts to the next step S913. Otherwise (N in S911), the processing unit 120 ends the flow.

Subsequently, the processing unit 120 calculates the distance from the present position of the user to a recommended course, that is, the distance from the present position to a closest point of the recommended course (S913).

Subsequently, the processing unit 120 determines whether the distance calculated in step S913 is equal to or smaller than a threshold (S915). When the distance is equal to or smaller than the threshold (N in S915), the processing unit 120 shifts to the next step S917. Otherwise (N in S915), the processing unit 120 shifts to step S921.

Subsequently, the processing unit 120 determines on the basis of the direction of the speed of the user at the present point in time (e.g., represented by a speed vector included in positioning data) and log data (log data other than the speed vector) up to the present point in time whether the user is running in the opposite direction in the course (S917 and S919).

When the user is running in the opposite direction (Y in S919), the processing unit 120 shifts to step S921. Otherwise (N in S919), the processing unit 120 ends the flow.

Subsequently, the processing unit 120 turns on the off-course flag (S921).

Subsequently, the processing unit 120 notifies the user that the user goes off course (S923) and ends the flow. The notification to the user is performed by display of an image (including a text image) in the display unit 170, emission of sound (including vibration) from the sound output unit 180, and the like. As a form of the notification, various forms can be used.

Note that, when the off-course flag is turned on, the processing unit 120 may automatically stop the navigation function. At this point, for example, the display unit 170 may display a recommended course, a recommended event, or the like instead of displaying the navigation screen. With this display, the user can examine a change of a course in which the user performs training to another course.

### 2. Action and Effects of the Embodiment

As explained above, the system in this embodiment acquires information concerning a physical condition (a physical fatigue degree and a psychological fatigue degree) of the user before the start of training (an activity) and presents, on the basis of the physical condition information, a recommended course and a recommended event recommended to the user as a course (a route) and an event in which the user performs the training. Therefore, the user is capable of appropriately selecting a course and a training event suitable for the physical condition of the user. Consequently, it is possible to support the user in improving the performance of the user to the maximum and minimizing a risk of injury of the user.

The system in this embodiment displays at least one recommended course (recommended route) recommended to the user as a course in which the user performs training and indicates at least a part of the at least one recommended route with a visual representation corresponding to a type (an event) of training performed in the part. Therefore, the user can determine a type (an event) of training performed in at least a part of a recommended route from a visual representation of the part. That is, the user can visually easily check a type (an event) of training that the user should perform in the part.

The system in this embodiment performs control for displaying at least one course (route) in which training (an activity) is performed and indicating at least a part of the at least one course with a visual representation corresponding to a type (an event) of training performed in the part. Therefore, the user can determine an event of training performed in at least a part of the course from a visual representation of the part. That is, the user can visually easily check a type of an activity performed in the part.

Further, with the system in this embodiment, the user can check a training achievement of the user on the feedback screen. Therefore, the user can easily perform not only training but also review after the training. The user can also easily communicate the training of the user to others. The user can also easily accurately receive advice for the training by disclosing the feedback screen to an instructor and the like of the user. The user can easily compare a recommended course and a recommended event presented from the system with a course and an event in which the user performs training. Therefore, the user can reduce a time consumed for analysis of the training of the user. Even if the user has little expert knowledge, the user can easily review a training menu and reflect the training menu on the next training. The user is capable of improving a training forming skill (a menu creation skill) by performing a series of reviews.

### 3. Modifications

### 3-1. Other Biological Data

The system in this embodiment may further improve accuracy of a recommended course and a recommended event by using biological data such as a blood pressure, a brain wave, a blood glucose level, a body temperature, the number of red blood cells, a hematocrit, and hemoglobin concentration of the user as log data (items that should be recorded) of the user. When it is difficult to acquire the biological data of the user with sensors, the user only has to input the biological data before training. For example, since it is difficult to mount a sensor called weight meter on the electronic device 1, it is conceivable that the user manually inputs data concerning weight or acquires the data through communication with the weight meter. The input by the user is performed via the operation unit 150 of the electronic device 1, the operation unit 23 of the information terminal 2, or the like.

The system in the embodiment may improve accuracy of a recommended course and a recommended event by using eat and drink data of the user as log data of the user. When it is difficult to acquire the food and drink data with sensors, the user only has to input the food and drink data before training. The input by the user is performed via the operation unit 150 of the electronic device 1, the operation unit 23 of the information terminal 2, and the like.

### 3-2. Expiration Date of a Recommended Course or the Like

The processing unit 31 of the server 4 may set an expiration date for a recommended course or a recommended event. This is because a physical condition of the user changes according to the elapse of time and the recommended course or the recommended event also changes according to the change in the physical condition. When the expiration date expires, the processing unit 31 of the server 4, the processing unit 21 of the information terminal 2, or the processing unit 120 of the electronic device 1 may notify the user to that effect or may update the recommended course or the recommended event instead of or in addition to the notification.

Note that a period of the notification or a period of the update are set on the basis of an elapsed time from acquisition time of the log data used for the determination of the recommended course or the recommended event, an elapsed time from presentation time to the user of the recommended course or the recommended event.

When presenting the recommended course or the recommended event to the user, the processing unit 31 of the server 4 may add a message to the user. The message can be represented by sound, an image, or the like.

### 3-3. Recommendation to Each of Users

The system in this embodiment may adjust parameters of processing for determining a recommended course or a recommended event, for example, as explained below according to a type of a user. Note that the user may input the type of the user to the system together with, for example, user body data or the system may automatically determine the type of the user from log data of the user.

### (1) Fun Runner

A fun runner is a runner whose main purpose is to enjoy running rather than, for example, improving an exercise achievement or reducing weight. The system adjusts the parameters such that a score of a course in which the user usually runs or a course similar to the course increases.

### (2) Athlete

An athlete is a user whose main purpose is to build up the body to, for example, participate in a race or the like. The system adjusts the parameters such that the user can gradually build up the body.

### (3) Person Using the System for the Purpose of Improving a Physical Condition, for Example, Diet

When a psychological fatigue degree input by a user is gradually deteriorating, the system notifies the user to that effect.

### 3-4. User Setting

In the system, it is desirable that various kinds of user setting are possible. For example, the system may cause the user to input the start of a recommended course or cause the user to designate at least a part of conditions (geographical conditions, the number of signals in a course, weather, undulation, etc.) used in determining a recommended course or a recommended event.

### 3-5. Log Data

When determining a recommended course or a recommended event, the system may use, as a part of log data, participation achievements (evens, contents, date and times, results, temperatures, weathers, etc.) in sports races of the user. The user may input the participation achievements to the system. For example, when determining a recommended course or a recommended event, the system may take into account an achievement in a race in which the user participates immediately before training.

### 3-6. Display of a Recommended Course or the Like

When a recommended course or a recommended event is indicated by a linear visual representation (a tube image, a block image, a rope image, a wire image, a ribbon image, an arrow mark, a block image row, a mark row, or the like), the length of the visual representation may be set to length corresponding to a distance of the recommended course or the recommended distance or may be set to length corresponding to a time of the recommended course or the recommended event.

### 3-7. Other Recommendations

The system determines a recommended course and a recommended event on the basis of log data before training. However, the system may determine a recommended pace on the basis of a heart rate (e.g., a heart rate during the last training) included in the log data. The recommended pace is a pace suitable for the cardiopulmonary ability of the user. For example, the system may recommend a gentle pace to a user who easily has a high heart rate and recommend a steep pace to a user who less easily has a high heart rate.

### 3-8. Sensor Types

The electronic device 1 in the embodiment can use, as a sensor, at least one of various sensors described below. The sensors include an acceleration sensor, a GPS sensor, an angular velocity sensor, a speed sensor, a heartbeat sensor (a chest belt, etc.), a pulse sensor (a sensor for measurement in a place other than the heart), a pedometer, a pressure sensor, an altitude sensor, a temperature sensor (an air temperature sensor or a body temperature sensor), a terrestrial magnetism sensor, a weight meter (used as an external device of the electronic device 1), an ultraviolet ray sensor, a perspiration sensor, a blood pressure sensor, an arterial blood oxygen saturation (SpO₂) sensor, a lactic acid sensor, and a blood glucose level sensor. The electronic device 1 may include other sensors.

### 3-9. Notification Form

The electronic device 1 or the information terminal 2 may notify information to the user using image display, using a sound output, vibration, light, a color (a light emission color of an LED or a display color of a display), or the like, or using a combination of at least two of the image display, the sound output, the vibration, the light, and the color.

### 3-10. Other Customization

The user may be able to (customize), in advance, at least a part of notification contents (including a notification period, a notification item, a notification form, a tabulation method, and notification order) to the user by the system in the embodiment.

### 3-11. Form of the Devices

At least one of the electronic device 1 and the information terminal 2 can be configured as various types of portable information devices such as a wrist-type electronic device, an earphone-type electronic device, a finger ring-type electronic device, an electronic device mounted on a sports instrument and used, a smartphone, a head mound display (HMD), and a head-up display (HUD).

### 3-12. Display Data (Tabulation Method)

Various methods can be adopted as a tabulation method for data notified to the user by the system. The tabulation method may be, for example, an average in a period, a value of a best, a value of a worst, a total, a transition (a graph), a target, an achievement degree, dispersion (the magnitude of fluctuation), a ratio, a predicted value calculated from a measurement value of a parameter (a time required to run a predetermined distance or a distance that the user can run in a predetermined time), or an evaluation of an activity (a score, a ratio of good evaluation, etc.).

### 3-13. Representation Method

As a representation method for the system to notify data to the user, at least one of methods described below can be adopted.

(1) Representing a transition using a line graph
(2) A bar graph
(3) A table of numerical values (which may be, for example, scrolled)
(4) Displaying a target and a result, a result and a prediction, a maximum/a minimum and an average, or the like side by side concerning a certain item
(5) When a predetermined condition is satisfied, changing display, for example, changing a color (white and black reversal, highlighting with a different character color or a background color, or changing a way of display (e.g., displaying a predetermined mark, flashing, or using a character larger than usual)

### 3-14. Optional Functions

Other functions may be mounted on at least one of the electronic device 1 and the information terminal 2. The other functions are, for example, publicly-known smartphone functions. The smartphone functions include, for example, a call function, a mail arrival notification function, a telephone arrival notification function, a communication function, and a camera function.

### 3-15. Events

Events treated by the system in this embodiment are not limited to the events explained above. Examples of the event include, besides the marathon, the running, and the walking, various events such as mountain climbing, trekking, race walking, skiing (including cross-country skiing and ski jumping), snowboarding, snow-shoe hiking, bicycling, swimming, triathlon, skating, motorcycling, trail running, golf, tennis, baseball, soccer, motor sports, boat, yacht, paragliding, kite, and dog sled. Note that it is unnecessary to present courses and training events concerning all the events described above. Courses and training events only have to be presented concerning at least one sports event treated by the system.

### 3-16. System Applications

As applications of the system in this embodiment, besides the sports, the system is also applicable to fitness diet, navigation, and rehabilitation. In all the cases, an action for moving the body can be regarded as activity. The system in this embodiment may perform logging of different items according to applications or may cause the user to select an application.

### 3-17. System Form

In the system in the embodiment, a part of the functions of the server 4 may be mounted on the information terminal 2 or the electronic device 1 or apart of the functions of the information terminal 2 or the electronic apparatus 1 may be mounted on the server 4. In the embodiment, a part or all of the functions of the electronic device 1 may be mounted on the information terminal 2. A part or all of the functions of the server 4 and the information terminal 2 may be mounted on the electronic device 1. A part or all of the functions of the server 4 and the electronic device 1 may be mounted on the information terminal 2. A plurality of electronic devices may cooperate with one another through communication to play apart or all of the functions of the system in the embodiment.

That is, the system in this embodiment can take all of forms described below.

(1) Electronic device (wrist device)+information terminal (smartphone or PC)+network+server
(2) Information terminal (smartphone or PC)+network+server
(3) Electronic device (wrist device)+network+server
(4) Electronic device (wrist device standalone)
(5) Information terminal (standalone)
(6) Device cooperation of electronic devices in any one of (1) to (5)

### 3-18. Positioning System

In the embodiment, the GPS is used as the global satellite positioning system. However, a global navigation satellite system (GNSS) may be used. For example, one or two or more of satellite positioning systems such as a QZSS (Quasi Zenith Satellite System), a GLONASS (GLObal Navigation Satellite System), a GALILEO, and a BeiDou (BeiDou Navigation Satellite System) may be used. A Satellite-based Augmentation System (SBAS) such as a WAAS (Wide Area Augmentation System) or an EGNOS (European Geostationary-Satellite Navigation Overlay Service) may be used in at least one of the satellite positioning systems.

### 4. Others

The disclosure is not limited to the embodiment. Various modified implementations are possible within the scope of the gist of the invention.

The embodiment and the modifications explained above are examples. The disclosure is not limited thereto. For example, the embodiment and the modifications can be combined as appropriate.

The disclosure includes configurations substantially the same as the configurations explained in the embodiment (e.g., configurations having the same functions, methods, and results or configurations having the same purposes and effects). The disclosure includes configurations in which non-essential portions of the configurations explained in the embodiments are replaced. The disclosure includes configurations that realize action and effects same as the action and effects of the configurations explained in the embodiment and configurations that can attain objects same as the objects of the embodiment. The disclosure includes configurations in which publicly-known techniques are added to the configurations explained in the embodiment.

What is claimed is:

1. An information output system comprising:
one or more processors or circuits configured to:
acquire physical condition information concerning a physical condition of a user before a start of an activity; and
output, on the basis of the physical condition information, a recommended route, which is a route recommended for the user to perform as the activity.

2. The information output system according to claim 1, wherein the physical condition information is information based on data from a sensor concerning the user.

3. The information output system according to claim 2, wherein the sensor includes at least one of a position sensor, a direction sensor, an air pressure sensor, an acceleration sensor, an angular velocity sensor, a pulse sensor, and a temperature sensor.

4. The information output system according to claim 3, wherein the data from the sensor includes at least one of data detected by the at least one sensor and data obtained by processing the data detected by the at least one sensor.

5. The information output system according to claim 1, wherein the physical condition information is information based on information input by the user.

6. The information output system according to claim 1, wherein the physical condition information includes at least one of information concerning a state of mind of the user and information concerning a state of body of the user.

7. The information output system according to claim 1, wherein the one or more processors or circuits output, as the recommended route, at least one route present within a predetermined distance from a position of the user before the start of the activity.

8. The information output system according to claim 1, wherein the one or more processors or circuits output, as the recommended route, a route having a high degree of recommendation among two or more routes present within a predetermined distance from a position of the user before the start of the activity.

9. The information output system according to claim 1, wherein the one or more processors or circuits is further configured to, when the user is moving in the recommended route, display a visual representation of a section in which the user moves in the recommended route differently from a visual representation of a section in which the user does not move.

10. The information output system according to claim 1, wherein the position of the user before the start of the activity is a global positioning system (GPS) position, and the recommended route is based on GPS coordinates.

11. An information output method comprising:
acquiring physical condition information concerning a physical condition of a user before a start of an activity; and
outputting, on the basis of the physical condition information, a recommended route, which is a route recommended for the user to perform as the activity.

12. Anon-transitory computer readable medium comprising computer program instructions that, when executed by a computer, cause the computer to:
acquire physical condition information concerning a physical condition of a user before a start of an activity; and
output, on the basis of the physical condition information, a recommended route, which is a route recommended for the user to perform as the activity.

13. A system comprising:
one or more sensors; and
one or more processors or circuits configured to:
acquire sensor data from the body of a user from the one or more sensors;
determine a physical condition of the user based on the sensor data;
determine, based on the physical condition of the user, a recommended activity route for the user; and
output, to a speaker or display, information that includes at least a portion of the recommended activity route.

14. The system of claim 13, wherein the one or more sensors includes at least one of: a position sensor, a direction sensor, an air pressure sensor, an acceleration sensor, an angular velocity sensor, a pulse sensor, and a temperature sensor.

15. The system of claim 13, wherein the physical condition of the user includes at least one of: position, direction, air pressure, acceleration, angular velocity, pulse, and temperature, of the user.

16. The system of claim 13, wherein the physical condition is information concerning a state of mind of the user and information concerning a state of body of the user.
